(19) United States
(12) Patent Application Publication
(10) Pub. No.: US 2026/0204562 A1
(43) Pub. Date: Jul. 16, 2026

(54) CATHODE SLURRY COMPOSITION, LITHIUM SECONDARY BATTERY CONTAINING CATHODE DERIVED FROM THE CATHODE SLURRY COMPOSITION AND METHOD OF MANUFACTURING CATHODE SLURRY COMPOSITION

(71) Applicant: Samsung SDI Co., Ltd., Yongin-si (KR)

(72) Inventors: Kyungho Yoon, Suwon-si (KR); Mokwon Kim, Suwon-si (KR); Bumwoo Park, Suwon-si (KR); Seungsik Hwang, Suwon-si (KR); Dongil Kang, Suwon-si (KR); Junhwan Ku, Suwon-si (KR)

(21) Appl. No.: 19/441,307

(22) Filed: Jan. 6, 2026

(30) Foreign Application Priority Data
Jan. 16, 2025 (KR) 10-2025-0006828

(51) Int. Cl. H01M 4/525; H01M 4/02; H01M 4/131; H01M 4/62; H01M 10/052; H01M 10/0562

(52) U.S. Cl. CPC H01M 4/525; H01M 4/131; H01M 4/622; H01M 4/625; H01M 10/052; H01M 10/0562; H01M 2004/021; H01M 2004/028; H01M 2300/008

(57) ABSTRACT

A cathode slurry composition, a lithium secondary battery including a cathode derived cathode slurry composition, and a method of manufacturing the cathode slurry composition. The cathode slurry composition includes a non-polar solvent, a sulfide-containing solid electrolyte, a cathode active material including a lithium transition metal oxide, and a binder, wherein the binder includes at least two of an ethylene-based monomer-derived repeating unit a, a propylene-based monomer-derived repeating unit b, or a diene-based monomer-derived repeating unit c.

### CROSS-REFERENCE TO RELATED APPLICATION

This application is based on and claims priority to Korean Patent Application No. 10-2025-0006828, filed on Jan. 16, 2025, in the Korean Intellectual Property Office, and all the benefits under 35 U.S.C. § 119, the disclosure of which is incorporated by reference herein in its entirety.

### BACKGROUND

### 1. Field

The disclosure relates to a cathode slurry composition, a lithium secondary battery containing a cathode derived from the cathode slurry composition, and a method of manufacturing the cathode slurry composition.

### 2. Description of the Related Art

To meet requirements for miniaturization and high performance of various devices, high energy density of lithium secondary batteries is becoming important, as well as miniaturization and weight reduction. That is, high-capacity lithium secondary batteries are becoming important.

Cathode active materials with high-capacity are being considered to implement lithium secondary batteries suitable for their applications.

Conventional cathode active materials have interior lifespan characteristics and low thermal stability due to side reactions. Therefore, there remains a need for a method of preventing deterioration of battery performance while using a cathode active material.

### SUMMARY

Provided is a cathode slurry composition having improved stability, for example by inhibiting side reactions with a sulfide-based solid electrolyte.

Provided is a lithium secondary battery having improved resistance characteristics and discharge characteristics by including a cathode derived from the cathode slurry composition.

Provided is a method of manufacturing the cathode slurry composition.

Additional aspects will be set forth in part in the description which follows and, in part, will be apparent from the description, or may be learned by practice of the presented embodiments of the disclosure.

According to an aspect of the disclosure, a cathode slurry composition includes
a non-polar solvent,
a sulfide-based solid electrolyte,
a cathode active material including a lithium transition metal oxide, and
a binder,
wherein the binder includes at least two repeating units that can be an ethylene-based monomer-derived repeating unit a, a propylene-based monomer-derived repeating unit b, or a diene-based monomer-derived repeating unit c.

According to another aspect of the disclosure, a lithium secondary battery includes
a cathode, an anode, and
an electrolyte disposed between the cathode and the anode,
wherein the electrolyte includes a sulfide-based solid electrolyte, and
the cathode includes a cathode current collector, and
a cathode active material layer disposed on the cathode current collector and derived from the cathode slurry composition.

According to another aspect of the disclosure, a method of manufacturing a cathode slurry composition includes
mixing a non-polar solvent, a sulfide-based solid electrolyte, a cathode active material including a lithium transition metal oxide, and a binder,
wherein the binder includes at least two of an ethylene-based monomer-derived repeating unit a, a propylene-based monomer-derived repeating unit b, or a diene-based monomer-derived repeating unit c.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1, 2, 3, 4, and 5 are cross-sectional views of lithium secondary batteries according to an embodiment;

FIG. 6 is an image showing results of a solubility evaluation of binders in a solvent according to Preparation Examples 1, 2, and 3 and Comparative Preparation Example 1, respectively;

FIG. 7 is an image showing cathode slurry compositions according to Example 2 and Comparative Examples 1 and 2 observed on Day 1;

FIG. 8 is an image showing cathode slurry compositions according to Example 2 and Comparative Examples 1 and 2 observed on Day 2;

FIG. 9 is an image showing cathode slurry compositions according to Example 2 and Comparative Examples 1 and 2 observed on Day 3; and

FIG. 10 is an image showing cathode slurry compositions according to Example 2 and Comparative Examples 1 and 2 observed on Day 1 whether a slurry layer is formed.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Various embodiments are illustrated in the accompanying drawings. The present disclosure and/or inventive concept may, however, be embodied in many different forms and should not be construed as limited to the embodiments set forth herein. Rather, the embodiments are provided so that this disclosure will be thorough and complete, and will fully convey the scope of the present disclosure and/or inventive concept to those skilled in the art. Like reference numerals in the drawings denote like elements.

It will be understood that if one element is referred to as being “on” another element, it may be directly on the other element, or intervening elements may also be present therebetween. If one element is referred to as being “directly on” another element, there is no intervening element therebetween.

Although the terms “first”, “second”, “third”, and the like may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer or section without departing from the teachings herein.

The terms used herein is for the purpose of describing particular embodiments only and is not intended to be limiting of the present disclosure and/or inventive concept. As used herein, an expression used in the singular (e.g., referred to as “a” or “an”) may encompass the expression “at least one”, unless otherwise indicated. The “at least one” should not be construed as singular. As used herein, the term “and/or” includes any and all combinations of one or more of the associated listed items. The terms such as “including” and/or “having” are intended to indicate the existence of features, regions, integers, processes, components, and/or elements disclosed in the specification, and are not intended to preclude the possibility that one or more other features, regions, integers, processes, components, and/or elements thereof may exist or may be added.

Spatially relative terms, such as “under”, “below”, “lower”, “on”, “above”, or “upper”, may be used herein for ease of description of the relationship of one element or feature to another element(s) or feature(s) as illustrated in the figures. It will be understood that the spatially relative terms are intended to encompass different orientations of a device in use or operation, in addition to the orientation depicted in the drawings. For example, if the device in the drawings is turned over, elements described as “below” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one or ordinary skill in the art to which this application belongs. Also, it will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments will be described herein with reference to schematic cross-sectional view of ideal embodiments. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles illustrated in the drawings may be rounded. Thus, the regions illustrated in the drawings are schematic in nature and their shapes are not intended to illustrate the actual shape of a region of a device and are not intended to limit the scope of claims.

The term “Group” refers to a group of elements in the periodic table numbered from 1 to 18 classified according to a classification system of The International Union of Pure and Applied Chemistry (“IUPAC”).

In the (i.e., this) disclosure, a “particle diameter” of particles indicates an average diameter of spherical particles or an average length of major axes of non-spherical particles. Particle diameters may be measured using a particle size analyzer (PSA). The “particle diameter” may be, for example, an average particle diameter. The “average particle diameter” may be, for example, a median particle diameter (D50).

D50 may refer to a particle diameter corresponding to 50% of the particles in a cumulative distribution curve measured by a laser diffraction method in which particles are accumulated in the order of particle diameter from the smallest particle to the largest particle.

D90 may refer to a particle diameter corresponding to 90% of the particles in a cumulative distribution curve measured by a laser diffraction method in which particles are accumulated in the order of particle diameter from the smallest particle to the largest particle.

D10 may refer to a particle diameter corresponding to 10% of the particles in a cumulative distribution curve measured by a laser diffraction method in which particles are accumulated in the order of particle diameter from the smallest particle to the largest particle.

In the disclosure, the term “-based”, e.g., the term “component-based” may include the component named, be derived from the component named, or include a derivative of the component named.

In the disclosure, the term “metal” may include metals and metalloids such as silicon and germanium in an elemental or ionic state.

In the disclosure, the term “alloy” may refer to a mixture of two or more metals.

In the disclosure, the term “electrode active material” refers to a material for electrodes allowing lithiation and deilithiation.

In the disclosure, the term “cathode active material” refers to a material for cathodes allowing lithiation and delithiation.

In the disclosure, the term “anode active material” refers to a material for anodes allowing lithiation and delithiation.

In the disclosure, the terms “lithiation” and “lithiating” refer to a process of adding lithium to an electrode active material.

In the disclosure, the terms “delithiation” and “delithiating” refer to a process of removing lithium from an electrode active material.

In the disclosure, the terms “charging” and “charge” may refer to a process of supplying electrochemical energy to a battery.

In the disclosure, the terms “discharging” and “discharge” may refer to a process of removing electrochemical energy from a battery.

In the disclosure, the terms “positive electrode” and “cathode” refer to an electrode in which electrochemical reduction and lithiation occur during discharging.

In the disclosure, the terms “negative electrode” and “anode” refer to an electrode in which electrochemical oxidation and delithiation occur during discharging.

While some embodiments have been described, alternatives, modifications, variations, improvements, and substantial equivalents that are or may be presently unforeseen may arise to applicants or others skilled in the art. The appended claims as filed and as they may be amended are intended to embrace all such alternatives, modification, variations, improvements, and substantial equivalents.

Hereinafter, a cathode slurry composition, a lithium secondary battery including a cathode derived therefrom, and a method of manufacturing the cathode slurry composition according to embodiments will be described in detail.

### Cathode Slurry Composition

A cathode slurry composition according to an embodiment includes: a non-polar solvent; a sulfide-based solid electrolyte; a cathode active material including a lithium transition metal oxide; and a binder, wherein the binder includes at least two of an ethylene-based monomer-derived repeating unit a, a propylene-based monomer-derived repeating unit b, and a diene-based monomer-derived repeating unit c. The cathode slurry composition includes the sulfide-based solid electrolyte, and the non-polar solvent to prevent side reactions with the sulfide-based solid electrolyte.

Without being bound by theory, it is believed that a polar solvent as is contained in conventional cathode slurry compositions may cause a side reaction with the sulfide-based solid electrolyte, not only impairing stability of a cathode slurry composition but also resulting in deteriorating cell performance of a lithium battery manufactured therefrom. On the contrary, the cathode slurry disclosed herein includes the non-polar solvent. It is believed that any side reaction between the non-polar solvent and the sulfide-based solid electrolyte is decreased or inhibited to easily provide a cathode slurry composition having excellent stability. A lithium battery including a cathode derived from the cathode slurry composition may have excellent resistance characteristics and discharge characteristics.

In addition to the non-polar solvent, the cathode slurry composition may include a binder including at least two repeating units. To obtain an improved cathode slurry using a nonpolar solvent, the repeating units may include at least two of the ethylene-based monomer-derived repeating unit a, the propylene-based monomer-derived repeating unit b, and the diene-based monomer-derived repeating unit c as a binder. The type and amount of each of the repeating units is selected to provide a binder having excellent solubility in non-polar solvents and excellent adhesion to a substrate, in particular a substrate used in a cathode. A lithium secondary battery including a cathode derived from the cathode slurry composition including the binder may have improved resistance characteristics and discharge characteristics by including the binder having excellent adhesion to a substrate.

For example, the binder may include the ethylene-based monomer-derived repeating unit a and the propylene-based monomer-derived repeating unit b. The binder may include only the ethylene-based monomer-derived repeating unit a and the propylene-based monomer-derived repeating unit b, or may include all three of the ethylene-based monomer-derived repeating unit a, the propylene-based monomer-derived repeating unit b, and the diene-based monomer-derived repeating unit c.

The ethylene-based monomer may include ethylene, and the propylene-based monomer may include propylene.

For example, the ethylene-based monomer-derived repeating unit a may be represented by Formula 1 below, and the propylene-based monomer-derived repeating unit may be represented by Formula 2 below.

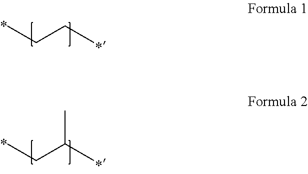

In Formulae 1 and 2,
* and *′ are each independently a binding site with an adjacent repeating unit.

The diene-based monomer may include ethylidene norbornene.

For example, the diene-based monomer-derived repeating unit c may be represented by Formula 3 below.

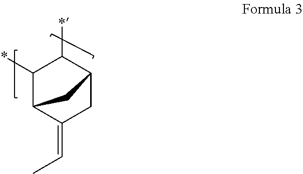

In Formulae 3, * and *′ are each independently a binding site with an adjacent repeating unit.

According to an embodiment, the binder may include a repeating unit represented by Formula 4 below.

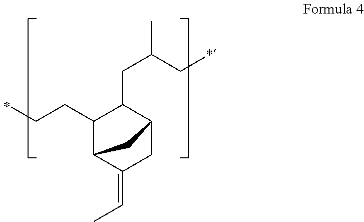

In Formulae 4, * and *′ are each independently a binding site with an adjacent repeating unit.

According to an embodiment, an amount of the ethylene-based monomer-derived repeating unit a included in the binder may be 55 wt % or less based on a total weight of the binder. For example, the amount of the ethylene-based monomer-derived repeating unit a included in the binder may be about 30 wt % to about 55 wt %, about 40 wt % to about 55 wt %, about 50 wt % to about 55 wt %, or about 52.5 wt % to about 55 wt % based on the total weight of the binder. For example, if the amount of the ethylene-based monomer-derived repeating unit a included in the binder satisfies the above ranges, solubility of the binder in the non-polar solvent may be superior.

According to an embodiment, an amount of the propylene-based monomer-derived repeating unit b included in the binder may be 45 wt % or less based on a total weight of the binder. For example, the amount of the propylene-based monomer-derived repeating unit b included in the binder may be about 30 wt % to about 45 wt %, about 35 wt % to about 45 wt %, about 38 wt % to about 45 wt %, or about 38 wt % to about 42.5 wt % based on the total weight of the binder.

According to an embodiment, an amount of the diene-based monomer-derived repeating unit c included in the binder may be 10 wt % or less based on the total weight of the binder. The amount of the diene-based monomer-derived repeating unit c included in the binder may be 7.5 wt % or less, 5 wt % or less, or 3 wt % or less based on the total weight of the binder. For example, the binder may not include the diene-based monomer-derived repeating unit c.

According to an embodiment, an amount of the binder in the cathode slurry composition may be about 0.1 wt % to about 10 wt % based on a total weight of the cathode slurry composition. For example, the amount of the binder may be about 0.2 wt % to about 5 wt % or about 0.5 wt % to about 2 wt % based on the total weight of the cathode slurry composition.

According to an embodiment, the binder may have a Mooney viscosity, ML1+4, 125° C., of 60 or more. The Mooney viscosity, ML1+4, 125° C., is measured by using a Mooney viscometer for 4 minutes at 125° C. after 1 minute of preheating.

According to an embodiment, the non-polar solvent may have a molecular weight of about 90 grams per mole (g/mol) to about 180 g/mol. The molecular weight of the non-polar solvent may be about 90 g/mol to about 150 g/mol. For example, with a molecular weight of the non-polar solvent satisfying the range, the non-polar solvent is slowly evaporated while preparing a cathode from the cathode slurry composition, so that the cathode may be easily prepared.

According to an embodiment, a boiling point (b.p.) of the non-polar solvent may be about 110° C. to about 220° C. The boiling point (b.p.) of the non-polar solvent may be about 110° C. to about 210° C.

According to an embodiment, the non-polar solvent may include tetralin, cymene, diisopropyl benzene, trimethyl benzene, toluene, or a combination thereof. For example, the non-polar solvent may include tetralin, cymene, diisopropyl benzene, trimethyl benzene, or a combination thereof.

According to an embodiment, the cathode active material may include a lithium transition metal oxide represented by Formulae 5 to 12.

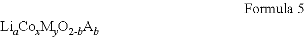

In Formula 5,
1.0≤a≤1.2, 0≤b≤0.2, 0.9≤x≤1, 0≤y≤0.1, and x+y=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br, or a combination thereof.

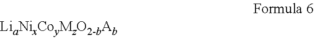

In Formula 6,
1.0≤a≤1.2, 0≤b≤0.2, 0.8≤x1, 0≤y≤0.3, 0<z≤0.3, and x+y+z=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is F, S, Cl, Br, or a combination thereof.

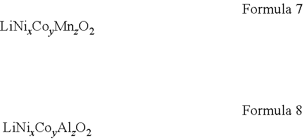

In Formulae 7 and 8, 0.8≤x≤0.95, 0≤y≤0.2, 0<z≤0.2 and x+y+z=1.

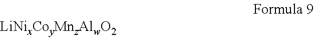

In Formula 9, 0.8≤x≤0.95, 0≤y≤0.2, 0<z≤0.2, 0<w≤0.2, and x+y+z+w=1.

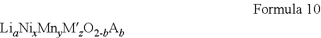

In Formula 10,
1.0≤a≤1.2, 0≤b≤0.2, 0<x≤0.3, 0.5≤y<1, 0<z≤0.3, and x+y+z=1,
M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is F, S, Cl, Br, or a combination thereof,

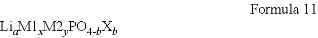

In Formula 11, 0.90≤a≤1.1, 0≤x≤0.9, 0≤y≤0.5, 0.9<x+y<1.1, and 0≤b≤2,
M1 is chromium (Cr), manganese (Mn), iron (Fe), cobalt (Co), nickel (Ni), copper (Cu), zirconium (Zr), or a combination thereof,
M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and
X is O, F, S, P or a combination thereof.

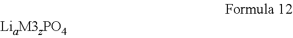

In Formula 12,
0.90≤a≤1.1 and 0.9≤z≤1.1, and
M3 is chromium (Cr), manganese (Mn), iron (Fe), cobalt (Co), nickel (Ni), copper (Cu), zirconium (Zr), or a combination thereof.

In an embodiment, particles of the cathode active material may be covered with a coating layer. The coating layer may prevent a side reaction between the cathode active material and the sulfide-based solid electrolyte. Without being bound by theory, he coating layer may include, for example, Li₂O—ZrO₂ (LZO), LiNbO₃, or Li₄Ti₅O₁₂ (LTO). A method of forming the coating layer may be one not adversely affecting physical properties of the cathode active material. The coating method may be, for example, spray coating, dip coating, or a combination thereof.

The cathode active material may be in particulate form, where a size of the cathode active material may be, for example about 0.1 micrometer (μm) to about 20 μm, about 0.5 μm to about 10 μm, or about 1 μm to about 5 μm. The cathode active material may be formed of, for example, single crystal particles or polycrystal particles.

According to an embodiment, the lithium transition metal oxide included in the cathode active material may include a first lithium transition metal oxide and a second lithium transition metal oxide, wherein the first lithium transition metal oxide may be a particulate large-diameter lithium transition metal oxide having a larger particle diameter than that of the second lithium transition metal oxide, and the second lithium transition metal oxide may be, for example, a particulate small-diameter lithium transition metal oxide having a smaller particle diameter than that of the first lithium transition metal oxide.

In an embodiment, a first coating layer including a first linear carbonaceous material (e.g., as described in further detail below) and a first solid electrolyte may be formed on at least a portion of the surface of a first particle including the large-diameter first lithium transition metal oxide. A second coating layer including a second linear carbonaceous material (e.g., as described in further detail below) and a second solid electrolyte may be formed on at least a portion of the surface of a second particle including the small-diameter second lithium transition metal oxide. In this case, a composite cathode active material including the second particle including the small-diameter second lithium transition metal oxide may be located in pores of a composite cathode active material including the first particle including the large-diameter first lithium transition metal oxide. Because the small-diameter particles are located in the pores between the large-diameter particles, ionic conductivity and/or electronic conductivity of a cathode including the composite cathode active materials may be improved. In addition, energy density of the cathode including the composite cathode active material may be improved. As a result, energy density and cycle characteristics of a lithium battery including the composite cathode active material may be improved.

For example, the lithium transition metal oxide may have a bimodal particle diameter distribution. For example, the composite cathode active material may have a bimodal particle diameter distribution with two peaks in a particle diameter distribution chart obtained by using a particle size analyzer (PSA) or the like. The bimodal particle diameter distribution may have a first peak corresponding to the first lithium transition metal oxide and a second peak corresponding to the second lithium transition metal oxide.

A particle diameter ratio of the first lithium transition metal oxide to the second lithium transition metal oxide may be, for example, about 2:1 to about 10:1, about 3:1 to about 10:1, about 3:1 to about 8:1, about 3:1 to about 6:1, or about 3:1 to about 5:1. With the particle diameter ratio of the first lithium transition metal oxide to the second lithium transition metal oxide satisfying the ranges, the energy density and cycle characteristics of the lithium battery including the composite cathode active material may further be improved.

A particle diameter of the first lithium transition metal oxide may be, for example about 10 μm to about 20 μm, about 10 μm to about 18 μm, or about 10 μm to about 15 μm. The particle diameter of the first lithium transition metal oxide may be, for example, an average particle diameter (D50). A particle diameter of the second lithium transition metal oxide may be, for example, about 1 μm to about 10 μm, about 2 μm to about 10 μm, about 4 μm to about 10 μm, about 1 μm to about 8 μm, about 1 μm to about 6 μm, or about 4 μm to about 6 μm. The particle diameter of the second lithium transition metal oxide may be, for example, an average particle diameter (D50). With the average particle diameters of the first lithium transition metal oxide and the second lithium transition metal oxide satisfying the ranges, energy density and/or cycle characteristics of a lithium battery including the composite cathode active material may further be improved. The particle diameters of the first lithium transition metal oxide and the second lithium transition metal oxide may be measured, for example, by a device using a laser diffraction or dynamic light-scattering. The particle diameters are measured by using, for example, a laser scattering particle size distribution analyzer (e.g., LA-920 from Horiba Instruments, Inc.), and may be a value of average particle diameter (D50) at 50% of a total cumulative particle diameter distribution of particles from the smallest particle diameter. Alternatively, the particle diameters of the first lithium transition metal oxide and the second lithium transition metal oxide may be measured from a scanning electron microscope (SEM) image or using an optical microscope.

A weight ratio of the first lithium transition metal oxide to the second lithium transition metal oxide may be, for example, about 90:10 to about 60:40, about 85:15 to about 65:35, about 80:20 to about 65:35, or about 75:25 to about 65:35. With the weight ratio of the first lithium transition metal oxide to the second lithium transition metal oxide satisfying the ranges, energy density and/or cycle characteristics of the lithium battery including the composite cathode active material may further be improved.

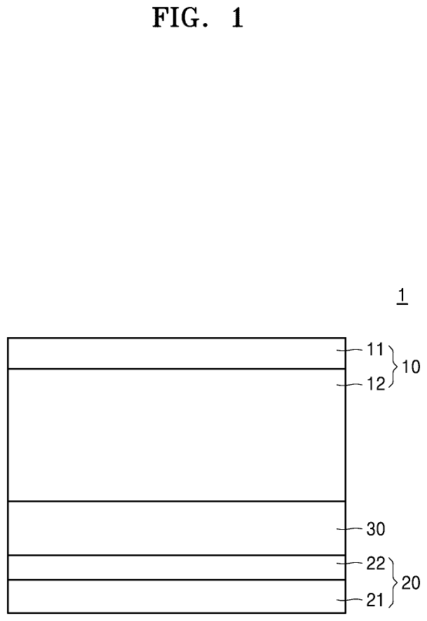

The cathode active material may have any particle shape, such as an irregular shape, a spherical shape or an elliptically spherical shape. A particle diameter of the cathode active material is not limited and may be within a range applicable to cathode active materials of conventional lithium secondary batteries. An amount of the cathode active material of a cathode active material layer (e.g., cathode active material layer 12 as shown in FIGS. 1-5 discussed below) is not particularly limited and may be in a range commonly applied to cathode active material layers of lithium batteries. The amount of the cathode active material included in the cathode active material layer (e.g., cathode active material layer 12 as shown in FIGS. 1-5 discussed below) may be about 80 wt % to about 99 wt %, about 80 wt % to about 95 wt %, or about 80 wt % to about 90 based on a total weight of the cathode active material layer 12.

According to an embodiment, the sulfide-based solid electrolyte may include at least one Li₂S—P₂S₅, Li₂S—P₂S₅—LiX wherein X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ wherein m and n are positive numbers and Z is Ge, Zn, or Ga, Li₂S—GeS₂, Li₂S—SiS₂—Li₃PO₄, Li₂S—SiS₂—LiₚMO_{q} wherein p and q are positive numbers and M is one of P, Si, Ge, B, Al, Ga, and In, Li₇₋ₓPS₆₋ₓClₓ wherein 0≤x≤2, Li₇₋ₓPS₆₋ₓBrₓ wherein 0≤x≤2, or Li₇₋ₓPS₆₋ₓIₓ, wherein 0≤x≤2.

According to an embodiment, the sulfide-based solid electrolyte may include an argyrodite-type solid electrolyte, wherein the argyrodite-type solid electrolyte may include at least one of Li₆PS₅Cl, Li₆PS₅Br, or Li₆PS₅I.

According to an embodiment, the argyrodite-type solid electrolyte has a density of about 1.5 grams per cubic centimeter (g/cc) to about 2.0 g/cc.

According to an embodiment, the solid electrolyte may have a particle diameter D50 of 1 μm or less. For example, the particle diameter D50 of the solid electrolyte may be about 0.1 μm to about 1 μm.

According to an embodiment, the cathode slurry composition may further include a conductive material, and the conductive material includes a linear carbonaceous material, wherein the linear carbonaceous material may be single-walled carbon nanotube (SWCNT), double-walled carbon nanotube (DWCNT), multi-walled carbon nanotube (MWCNT), or a combination thereof.

According to an embodiment le, a length of the linear carbonaceous material may be 2,000 μm or more, 1,200 μm or more, 1,400 μm or more, 1,600 μm or more, 1,800 μm or more, or 2,000 μm or more. For example, the length of the linear carbonaceous material may be about 1,200 μm to about 10,000 μm, about 1,400 μm to about 10,000 μm, about 1,600 μm to about 10,000 μm, about 1,800 μm to about 10,000 μm, about 2,000 μm to about 10,000 μm, about 1,000 μm to about 5,000 μm, or about 1,500 μm to about 5,000 μm.

According to an embodiment, a diameter of the linear carbonaceous material 130 may be about 50 nm to about 100 nm.

According to an embodiment, the cathode slurry may further optionally include an additional conductive material other than the above-described linear carbonaceous material.

The optional additional conductive material other than the linear carbonaceous material may be, for example, a carbonaceous conductive material, a metallic conductive material, or a combination thereof. The carbonaceous conductive material may be, for example, graphite, carbon black, acetylene black, Ketjen black, carbon fiber, or a combination thereof, but is not limited thereto, and a carbonaceous conductive materials commonly available in the art may also be used. The metallic conductive material may be metal powder, metal fiber, or a combination thereof, but is not limited thereto, and any metallic conductive materials commonly available in the art may also be used.

An amount of the conductive material (e.g., linear carbonaceous material or linear carbonaceous material and optional additional conductive material) included in the cathode slurry composition may be, for example, about 1 wt % to about 30 wt %, about 1 wt % to about 20 wt %, or about 1 wt % to about 10 wt % based on a total weight of solids (i.e., excluding the non-polar solvent) of the cathode slurry composition.

The cathode slurry composition may further include an additive such as a filler, a coating agent for the active material (e.g., the linear carbonaceous material and/or other coating agent), a dispersant, and an ion-conductive adjuvant, in addition to the above-described cathode active material, sulfide-based solid electrolyte, binder, and conductive material.

The filler, the coating agent, the dispersant, and the ion-conductive adjuvant included in the cathode slurry composition may be any known materials commonly used in electrodes of lithium secondary batteries including a sulfide-based solid electrolyte.

A cathode according to an embodiment includes: a cathode current collector; and a cathode active material layer disposed on the cathode current collector and derived from the above-described cathode slurry composition.

According to an embodiment, the above-described cathode slurry composition is directly applied onto the cathode current collector and dried to prepare a cathode in which the cathode active material layer is formed directly on the cathode current collector. According to another embodiment, the cathode slurry composition is cast on a separate support and a cathode active material layer, e.g., a film, is separated from the support may be laminated directly on the cathode current collector to prepare a cathode in which the cathode active material layer is formed.

The cathode slurry composition of the disclosure is prepared by mixing the non-polar solvent, the sulfide-based solid electrolyte, the cathode active material including the lithium transition metal oxide; and the binder. The binder includes at least two of the ethylene-based monomer-derived repeating unit a, the propylene-based monomer-derived repeating unit b, and the diene-based monomer-derived repeating unit c.

FIGS. 1 to 5 are cross-sectional views of lithium secondary batteries according to an embodiment.

A lithium secondary battery 1 according to another embodiment includes a cathode 10 including a cathode active material layer 12 derived from the above-described cathode slurry composition. Because the lithium secondary battery 1 includes the above-described cathode 10, resistance characteristics and discharge characteristics of the lithium secondary battery may be improved.

The lithium secondary battery 1 includes: a cathode 10; an anode 20; and an electrolyte layer 30 disposed between the cathode 10 and the anode 20, wherein the electrolyte layer 30 includes the sulfide-based solid electrolyte, and the cathode 10 includes: a cathode current collector 11; and a cathode active material layer 12 disposed on the cathode current collector 11 and derived from the above-described cathode slurry composition.

In the cathode 10, the cathode current collector 11 may be, for example, in the form of a plate or foil formed of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or any alloy thereof. The cathode current collector 11 may be omitted. The cathode current collector 11 may have a thickness of, for example, about 1 μm to about 100 μm, about 1 μm to about 50 μm, about 5 μm to about 25 μm, or about 10 μm to about 20 μm.

The cathode current collector 11 may include, for example, a base film and a metal layer disposed on one or both sides of the base film. The base film may include, for example, a polymer. The polymer may be, for example, a thermoplastic polymer. The polymer may include, for example, polyethylene terephthalate (PET), polyethylene (PE), polypropylene (PP), polybutylene terephthalate (PBT), polyimide (PI), or a combination thereof. The base film may be, for example, an insulator. If the base film includes an insulating thermoplastic polymer, the base film may soften or liquefy in the event of a short circuit to stop the operation of a battery, thereby inhibiting a rapid increase in currents. The metal layer may include, for example, indium (In), copper (Cu), magnesium (Mg), stainless steel, titanium (Ti), iron (Fe), cobalt (Co), nickel (Ni), zinc (Zn), aluminum (Al), germanium (Ge), or an alloy thereof. The metal layer may act as an electrochemical fuse and is cut by an overcurrent, thereby preventing a short circuit. By controlling a thickness of the metal layer, a limiting current and a maximum current may be adjusted. The metal layer may be plated or deposited on the base film. As the thickness of the metal layer decreases, the limiting current and/or maximum current of the cathode current collector 11 decreases, so that stability of the lithium battery may be improved in the event of a short circuit. A lead tab may be added onto the metal layer for connection with the outside. The lead tab may be welded to the metal layer or a metal layer/base film stack structure by ultrasonic welding, laser welding, spot welding, and the like. While the base film and/or the metal layer melt during welding, the metal layer may be electrically connected to the lead tab. A metal chip may further be added between the metal layer and the lead tab for stronger welding between the metal layer and the lead tab. The metal chip may be a chip of the same material as the metal of the metal layer. The metal chip may be, for example, metal foil and metal mesh. The metal chip may be, for example, aluminum foil, copper foil, and SUS foil. By disposing the metal chip on the metal layer and performing welding, the lead tab may be welded to a metal chip/metal layer stack structure or a metal chip/metal layer/base film stack structure. While the base film, the metal layer, and/or the metal chip melt during welding, the metal layer or the metal layer/metal chip stack structure may be electrically connected to the lead tab. A metal chip and/or a lead tab may further be added to a portion of the metal layer. The base film may have a thickness of, for example, about 1 μm to about 50 μm, about 1.5 μm to about 50 μm, about 1.5 μm to about 40 μm, or about 1 μm to about 30 μm. With the thickness of the base film satisfying the above-described ranges, the weight of an electrode assembly may be more effectively reduced. A melting point of the base film may be, for example, about 100° C. to about 300° C., about 100° C. to about 250° C., or about 100° C. to about 200° C. Because the base film has a melting point satisfying the above-described ranges, the base film melts during a process of welding the lead tab to be easily combined with the lead tab. To improve adhesion between the base film and the metal layer, surface treatment such as corona treatment may be performed on the base film. A thickness of the metal layer may be, for example, about 0.01 μm to about 3 μm, about 0.1 μm to about 3 μm, about 0.1 μm to about 2 μm, or about 0.1 μm to about 1 μm. With the thickness of the metal layer satisfying the above-described ranges, stability of the electrode assembly may be obtained while maintaining conductivity thereof. A thickness of the metal chip may be, for example, about 2 μm to about 10 μm, about 2 μm to about 7 μm, or about 4 μm to about 6 μm. With the thickness of the metal chip satisfying the above-described ranges, the metal layer may be more easily connected to the lead tab. If the cathode current collector 11 has the above-described structure, the weight of the cathode may be reduced, so that energy density of the cathode and the lithium battery may be increased.

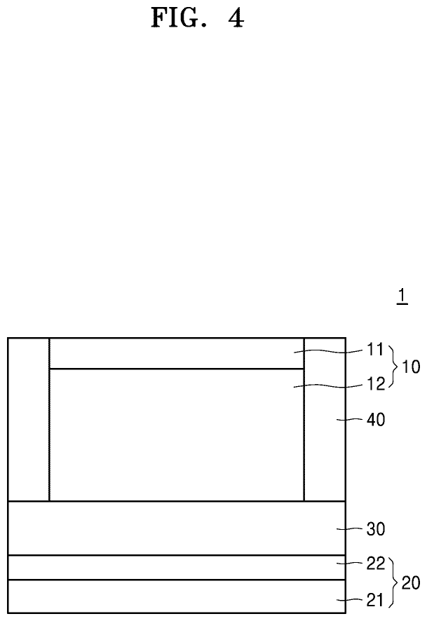

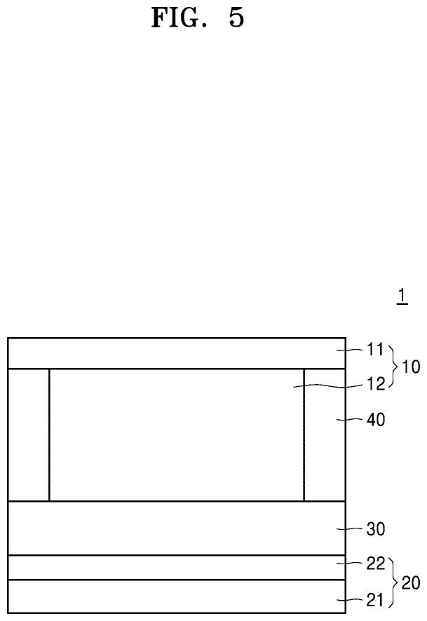

Referring to FIGS. 4 and 5, the cathode 10 includes a cathode current collector 11, and a cathode active material layer 12 disposed on one surface of the cathode current collector, and an inactive member 40 is disposed on one side surface of the cathode 10. Referring to FIG. 4, the inactive member 40 is disposed on one side surface of each of the cathode active material layer 12 and the cathode current collector 11. Referring to FIG. 5, the inactive member 40 is disposed on one side surface of the cathode active material layer 12 and between the electrolyte layer 30 and the cathode current collector 11 opposite to the electrolyte layer 30. The inactive member 40 may not be disposed on one side surface of the cathode current collector 11. The electrolyte layer 30 may include, for example, a sulfide-based solid electrolyte.

By including the inactive member 40, occurrence of cracks of the electrolyte layer 30 is inhibited while manufacturing and/or charging and discharging the lithium secondary battery 1, so that cycle characteristics of the lithium secondary battery 1 may be improved. In a lithium secondary battery 1 not including the inactive member 40, non-uniform pressure is applied to the electrolyte layer 30 in contact with the cathode 10 while manufacturing and/or charging and discharging the lithium secondary battery 1, so that cracks occur in the electrolyte layer 30 resulting in an increase in short circuits by the growth of lithium metal thereby.

In the lithium secondary battery 1, a thickness of the inactive member 40 may be greater than that of the cathode active material layer 12 or the same as that of the cathode active material layer 12. Alternatively, in the lithium secondary battery 1, the thickness of the inactive member 40 is substantially the same as that of the cathode 10. Because the thickness of the inactive member 40 is the same as that of the cathode 10, a uniform pressure is applied between the cathode 10 and the electrolyte layer 30 and the cathode 10 is in sufficiently close contact with the electrolyte layer 30, so that interfacial resistance between the cathode 10 and the electrolyte layer 30 may be reduced. In addition, because the electrolyte layer 30 is sufficiently sintered during a pressing/manufacturing process of the lithium secondary battery 1, internal resistance of the electrolyte layer 30 and the lithium secondary battery 1 including the same may be reduced.

The inactive member 40 is in contact with the electrolyte layer 30 in a state of surrounding side surfaces of the cathode 10. Because the inactive member 40 is in contact with the electrolyte layer 30 in a state of surrounding side surfaces of the cathode 10, cracks, which are caused by a pressure difference in the electrolyte layer 30 not in contact with the cathode 10 during a pressing process, may be effectively inhibited. The inactive member 40 surrounding the side surfaces of the cathode 10 is separated from the anode 20, more specifically, from a first anode active material layer 22. The inactive member 40 is in contact with the electrolyte layer 30 while surrounding side surfaces of the cathode 10 and is separated from the anode 20. Therefore, the possibility of a short circuit caused by physical contact between the cathode 10 and the first anode active material layer 22 or the possibility of a short circuit caused by overcharging of lithium may be inhibited. For example, if the inactive member 40 is disposed on one side surface of the cathode active material layer 12 as well as one side surface of the cathode current collector 11, the possibility of a short circuit caused by contact between the cathode current collector 11 and the anode 20 is inhibited more effectively.

Referring to FIGS. 4 and 5, the inactive member 40 may extend from one side surface of the electrolyte layer 30 to an end portion of the electrolyte layer 30. By extending the inactive member 40 to the end portion of the electrolyte layer 30, cracks occurring in the end portion of the electrolyte layer 30 may be inhibited. The end portion of the electrolyte layer 30 may be the outermost portion in contact with a side surface of the electrolyte layer 30. The inactive member 40 extends to the outermost portion in contact with the side surface of the electrolyte layer 30. The inactive member 40 is separated from the anode 20, more specifically, the first anode active material layer 22. The inactive member 40 extends to the end portion of the electrolyte layer 30 but not in contact with the anode 20. The inactive member 40 fills a space between one side surface of the cathode 10 and the end portion of the electrolyte layer 30.

Referring to FIGS. 4 and 5, a width of the inactive member 40 extending from one side surface of the cathode 10 to the end portion of the electrolyte layer 30 is, for example, about 1% to about 30%, about 1% to about 25%, about 1% to about 20%, about 1% to about 15%, about 1% to about 10%, or about 1% to about 5% of a width of the cathode 10 between one side surface and the other side surface opposite to the one side surface. With a too large width of the inactive member 40, energy density of the lithium secondary battery 1 may decrease. With a too small width of the inactive member 40, the effects of the inactive member 40 are negligible.

An area of the cathode 10 may be smaller than an area of the electrolyte layer 30 in contact with the cathode 10. The inactive member 40 arranged to surround side surfaces of the cathode 10 compensates for a difference in area between the cathode 10 and the electrolyte layer 30. Because the area of the inactive member 40 compensates for the difference between the area of the cathode 10 and the area of the electrolyte layer 30, cracks of the electrolyte layer 30 caused by a pressure difference during a pressing process may be effectively inhibited. For example, a sum of the area of the cathode 10 and the area of the inactive member 40 is the same as the area of the electrolyte layer 30. The electrolyte layer 30 may be, for example, a solid electrolyte layer.

The area of the cathode 10 may be, for example, less than 100%, 99% or less, 98% or less, 97% or less, 96% or less, or 95% or less of the area of the electrolyte layer 30. The area of the cathode 10 may be, for example, about 50% but less than 100%, about 50% to about 99%, about 55% to about 98%, about 60% to about 97%, about 70% to about 96%, about 80% to about 95%, or about 85% to about 95% of the area of the electrolyte layer 30.

If the area of the cathode 10 is the same as or greater than the area of the electrolyte layer 30, the possibility of a short circuit caused by physical contact between the cathode 10 and the first anode active material layer 22 or a short circuit caused by overcharging of lithium may increase. The area of the cathode 10 may be, for example, the same as the area of the cathode active material layer 12. The area of the cathode 10 may be, for example, the same as the area of the cathode current collector 11.

The area of the inactive member 40 is, for example, 50% or less, 40% or less, 30% or less, 20% or less, or 10% or less of the area of the cathode 10. The area of the inactive member 40 is, for example, about 1% to about 50%, about 5% to about 40%, about 5% to about 30%, about 5% to about 20%, or about 5% to about 15% of the area of the cathode 10.

The area of the cathode 10 may be smaller than an area of the anode current collector 21. The area of the cathode 10 may be, for example, less than 100%, 99% or less, 98% or less, 97% or less, 96% or less, or 95% or less or that of the anode current collector 21. The area of the cathode 10 may be, for example, from about 50% but less than 100%, about 50% to about 99%, about 55% to about 98%, about 60% to about 97%, about 70% to about 96%, about 80% to about 95%, or about 85% to about 95% of the area of the anode current collector 21. The area of the anode current collector 21 may be, for example, the same as that of the anode 20. The area of the anode current collector 21 may be, for example, the same as that of the first anode active material layer 22.

As used herein, the “same” area, length, width, thickness, and/or shape may include all cases having “substantially same” area, length, width, thickness, and/or shape except that the area, length, thickness, and/or shape are intentionally modified. The “same” area, length, width, and/or thickness includes, for example, a range of unintended differences less than 3%, less than 2%, less than 1%, less than 0.5%, and less than 0.1% in the area, length, width, and/or thickness.

A thickness of the inactive member 40 is, for example, greater than a thickness of the first anode active material layer 22. The thickness of the first anode active material layer 22 is, for example, 50% or less, 40% or less, 30% or less, 20% or less, or 10% or less of the thickness of the inactive member 40. The thickness of the first anode active material layer 22 may be about 1% to about 50%, about 1% to about 40%, about 1% to about 30%, about 1% to about 20%, or about 1% to about 10% of the thickness of the inactive member 40.

The inactive member 40 may be a gasket. By using the gasket as the inactive member 40, cracks occurring in the electrolyte layer 30 by a pressure difference during a pressing process may be more effectively inhibited.

The inactive member 40 may have, for example, a single-layer structure. In other embodiments, although not shown in the drawings, the inactive member 40 may have a multilayer structure. In the inactive member 40 having a multilayer structure, each layer may have a different composition. The inactive member 40 having a multilayer structure may have a two-layer structure, a three-layer structure, a four-layer structure, or a five-layer structure. The inactive member 40 having a multilayer structure may include, for example, at least one adhesive layer and at least one support layer. The adhesive layer effectively prevents separation of the cathode 10 from the electrolyte layer 30 caused by a volume change of the cathode 10 during a charging and discharging process of the lithium secondary battery 1 and provides binding strength between the support layer and other layers, so as to increase strength of a film of the inactive member 40. The support layer provides a supporting force to the inactive member 40, and prevents non-uniform application of pressure to the electrolyte layer 30 during a pressing process or a charging and discharging process and deformation of the lithium secondary battery 1.

The inactive member 40 may be, for example, a flame-retardant inactive member. Because a flame-retardant inactive member provides flame retardancy, thermal runaway and ignition of the lithium secondary battery 1 may be prevented. As a result, safety of the lithium secondary battery 1 may further be improved. Because the flame-retardant inactive member absorbs moisture remaining in the lithium secondary battery 1, deterioration of the lithium secondary battery 1 is prevented so that lifespan characteristics of the lithium secondary battery 1 may be improved.

The flame-retardant inactive member includes, for example, a matrix and a filler. The matrix may include, for example, a substrate and a reinforcement. The matrix includes, for example, a fibrous substrate and a fibrous reinforcement. By including the substrate, the matrix may have elasticity. Therefore, the matrix effectively accepts a volume change during charging and discharging of the lithium secondary battery 1 and may be arranged in various positions. The substrate included in the matrix includes, for example, a first fibrous material. Because the substrate includes the first fibrous material, a volume change of the cathode 10 is effectively accepted during charging and discharging of the lithium secondary battery 1, and deformation of the inactive member 40 caused by the volume change of the cathode 10 may be effectively inhibited. The first fibrous material is, for example, a material having an aspect ratio of 5 or more, 20 or more, or 50 or more. The first fibrous material is, for example, a material having an aspect ratio of about 5 to about 1000, about 20 to about 1000, or about 50 to about 1000. The first fibrous material is, for example, an insulating material. If the first fibrous material is an insulating material, a short circuit occurring between the cathode 10 and the anode 20 caused by lithium dendrite and the like formed during a charging and discharging process of the lithium secondary battery 1 may be effectively inhibited. The first fibrous material includes, for example, at least one of pulp fibers, insulating polymer fibers, or ion-conductive polymer fibers. Because the matrix includes the reinforcement, strength of the matrix is increased. Therefore, the matrix may prevent an excessive volume change during charging and discharging of the lithium secondary battery 1 and prevent deformation of the lithium secondary battery 1. The reinforcement included in the matrix includes, for example, a second fibrous material. Because the reinforcement includes the second fibrous material, strength of the matrix may be increased more uniformly. The second fibrous material is, for example, a material having an aspect ratio or 3 or more, 5 or more, or 10 or more. The second fibrous material is, for example, a material having an aspect ratio of about 3 to about 100, about 5 to about 100, or about 10 to about 100. The second fibrous material is, for example, a flame-retardant material. If the second fibrous material is a flame-retardant material, ignition caused by thermal runaway occurring during a charging and discharging process of the lithium secondary battery 1 or external impact may be effectively inhibited. The second fibrous material is, for example, glass fibers, metal oxide fibers, and ceramic fibers.

The flame-retardant inactive member includes a filler in addition to the matrix. The filler may be located inside the matrix, on the surface of the matrix, or both inside and on the surface of the matrix. The filler is, for example, an inorganic material. The filler included in the flame-retardant inactive member is, for example, a moisture getter. The filler absorbs moisture, for example, at a temperature below 100° C. to remove moisture remaining in the lithium secondary battery 1, thereby preventing the lithium secondary battery 1 from deteriorating. In addition, if the temperature of the lithium secondary battery 1 exceeds 150° C. by thermal runway occurring during a charging and discharging process of the lithium secondary battery 1 or external impact, the filler may release the absorbed moisture so that ignition of the lithium secondary battery 1 may be effectively inhibited. That is, the fille is, for example, a flame retardant. The filler is, for example, a metal hydroxide having moisture absorbency. The metal hydroxide included in the filler is, for example, Mg(OH)₂, Fe(OH)₃, Sb(OH)₃, Sn(OH)₄, Tl(OH)₃, Zr(OH)₄, Al(OH)₃, or a combination thereof. An amount of the filler included in the flame-retardant inactive member is, for example, about 10 parts by weight to about 80 parts by weight, about 20 parts by weight to about 80 parts by weight, about 30 parts by weight to about 80 parts by weight, about 40 parts by weight to about 80 parts by weight, about 50 parts by weight to about 80 parts by weight, about 60 parts by weight to about 80 parts by weight, or about 65 parts by weight to about 80 parts by weight based on 100 parts by weight of the flame-retardant inactive member 40.

The flame-retardant inactive member may further include, for example, a binder. The binder may include, for example, a curable polymer or a non-curable polymer. The curable polymer is a polymer cured by heat and/or pressure. The curable polymer is, for example, a solid at room temperature. The flame-retardant inactive member 40 includes, for example, a thermo-pressure curable film and/or a cured product thereof. The thermo-pressure curable polymer is, for example, TSA-66 manufactured by Toray.

The flame-retardant inactive member may further include another material in addition to the above-described substrate, reinforcement, filler, and binder. The flame-retardant inactive member may further include, for example, at least one of paper, an insulating polymer, an ion-conductive polymer, an insulating inorganic material, an oxide-based solid electrolyte, or a sulfide-based solid electrolyte. The insulating polymer may be, for example, an olefin-based polymer such as polypropylene (PP) and/or polyethylene (PE).

A density of the substrate or the reinforcement included in the flame-retardant inactive member may be, for example, about 10% to about 300%, about 10% to about 150%, about 10% to about 140%, about 10% to about 130%, or about 10% to about 120% of a density of the composite cathode active material included in the cathode active material layer 12.

The inactive member 40 may be a member not including an electrochemically active material, such as an electrode active material. The electrode active material is a material that allows intercalation/deintercalation of lithium. The inactive member 40 may be formed of any material commonly used in the art, other than the electrode active material.

Referring FIGS. 1 to 5, the anode 20 includes the first anode active material layer 22. The first anode active material layer 22 may include, for example, an anode active material and a binder.

The anode active material included in the first anode active material layer 22 may be, for example, a material for anodes allowing formation of an alloy or compound with lithium.

The anode active material included in the first anode active material layer 22 may be, for example, in the form of particles. The anode active material in the form of particles may have an average particle diameter of, for example, 4 μm or less, 3 μm or less, 2 μm or less, 1 μm or less, 500 nm or less, 300 nm or less, or 100 nm or less. The anode active material in the form of particles may have an average particle diameter of, for example, about 10 nm to about 4 μm, about 10 nm to about 3 μm, about 10 nm to about 2 μm, about 10 nm to about 1 μm, about 10 nm to about 500 nm, about 10 nm to about 300 nm, or about 10 nm to about 100 nm. The average particle diameter of the anode active material within the ranges described above may facilitate reversible absorbing and/or desorbing of lithium during charging and discharging. The average particle diameter of the anode active material may be, for example, an average diameter D50 measured using for example, a laser particle size analyzer.

The anode active material included in the first anode active material layer 22 may include, for example, at least one of a carbonaceous anode active material or a metal or metalloid anode active material.

The carbonaceous anode active material may include, for example amorphous carbon, crystalline carbon, porous carbon, or a combination thereof.

The carbonaceous anode active material may be, for example, amorphous carbon. The amorphous carbon may be, for example, carbon black (CB), acetylene black (AB), furnace black (FB), Ketjen black (KB), or graphene, but is not limited thereto, and any carbon classified as amorphous carbon in the art may also be used. Amorphous carbon may be carbon that does not have crystallinity, or has very low crystallinity, and may be distinguished from crystalline carbon or graphite-based carbon.

The carbonaceous anode active material may be, for example, porous carbon. A volume of pores in the porous carbon may be, for example, about 0.1 cc/g to about 10.0 cc/g, about 0.5 cc/g to about 5 cc/g, or about 0.1 cc/g to about 1 cc/g. The porous carbon may have an average pore diameter of, for example, about 1 nm to about 50 nm, about 1 nm to about 30 nm, or about 1 nm to about 10 nm. The porous carbon may have a BET specific surface area of, for example, about 100 square meters per gram (m²/g) to about 3000 m²/g.

The metal or metalloid anode active material includes at least one of gold (Au), platinum (Pt), palladium (Pd), silicon (Si), silver (Ag), aluminum (Al), bismuth (Bi), tin (Sn), zinc (Zn), or a combination thereof, but is not limited thereto, and any known metal anode active materials or metalloid anode active materials capable of forming an alloy or compound with lithium may also be used. For example, nickel (Ni) may not be a metal anode active material, because Ni does not form an alloy with lithium.

The first anode active material layer 22 includes one type of the anode active materials or a mixture of a plurality of different anode active materials among these anode active materials. For example, the first anode active material layer 22 may include only amorphous carbon or may include at least one of gold (Au), platinum (Pt), palladium (Pd), silicon (Si), silver (Ag), aluminum (Al), bismuth (Bi), tin (Sn), or zinc (Zn). Alternatively, the first anode active material layer 22 may include a mixture of amorphous carbon and at least one of gold (Au), platinum (Pt), palladium (Pd), silicon (Si), silver (Ag), aluminum (Al), bismuth (Bi), tin (Sn), or zinc (Zn). A mixing ratio of amorphous carbon to a metal such as gold is a weight ratio, and may be, for example, but is not limited thereto, about 99:1 to about 1:99, about 10:1 to about 1:2, about 5:1 to about 1:1, or about 4:1 to about 2:1, and may be selected in accordance with characteristics of the lithium secondary battery 1. With the composition of the anode active material, cycle characteristics of the lithium secondary battery 1 may further be improved.

The anode active material included in the first anode active material layer 22 may include, for example, a mixture of first particles formed of amorphous carbon and second particles formed of a metal or metalloid. The metal or metalloid may include, for example, gold (Au), platinum (Pt), palladium (Pd), silicon (Si), silver (Ag), aluminum (Al), bismuth (Bi), tin (Sn), and zinc (Zn). The metalloid may be, alternatively, a semiconductor. An amount of the second particles may be about 1 to about 99 wt %, about 1 wt % to about 60 wt %, about 8 wt % to about 60 wt %, about 10 wt % to about 50 wt %, about 15 wt % to about 40 wt %, or about 20 wt % to about 30 wt %, based on a total weight of the mixture. With the amount of the second particles satisfying the ranges, cycle characteristics of the lithium secondary battery 1 may further be improved.

Alternatively, the first anode active material layer 22 may include a composite anode active material. The composite anode active material may include, for example, a carbonaceous support and a metallic anode active material supported on the carbonaceous support. If the composite anode active material has such a structure, localization of the metallic anode active material may be inhibited in the first anode active material layer and uniform distribution may be obtained. As a result, cycle characteristics of the lithium secondary battery 1 including the first anode active material layer 22 may further be improved.

The metallic anode active material supported on the carbonaceous support may include, for example, a metal, a metal oxide, a composite of a metal and a metal oxide, or a combination thereof. The metal may include, for example, gold (Au), platinum (Pt), palladium (Pd), silicon (Si), silver (Ag), aluminum (Al), bismuth (Bi), tin (Sn), tellurium (Te), and zinc (Zn). The metal oxide may include, for example, a gold (Au) oxide, a platinum (Pt) oxide, a palladium (Pd) oxide, a silicon (Si) oxide, a silver (Ag) oxide, an aluminum (Al) oxide, a bismuth (Bi) oxide, a tin (Sn) oxide, a tellurium (Te) oxide, and a zinc (Zn) oxide. The metal oxide may include, for example, AuₓO_{y} (wherein 0<x≤2 and 0<y≤3), PtₓO_{y} (wherein 0<x≤1 and 0<y≤2), PdₓO_{y} (wherein 0<x≤1 and 0<y≤1), SiₓO_{y} (wherein 0<x≤1 and 0<y≤2), AgₓO_{y} (wherein 0<x≤2 and 0<y≤1), AlₓO_{y} (wherein 0<x≤2 and 0<y≤3), BiₓO_{y} (wherein 0<x≤2 and 0<y≤3), SnₓO_{y} (wherein 0<x≤1 and 0<y≤2), TeₓO_{y} (wherein 0<x≤1 and 0<y≤3), ZnₓO_{y} (wherein 0<x$1 and 0<y≤1), or a combination thereof. The composite of a metal and a metal oxide may include, for example, a composite of Au and AuₓO_{y} (wherein 0<x≤2 and 0<y≤3), a composite of Pt and PtₓO_{y} (wherein 0<x≤1 and 0<y≤2), a composite of Pd and PdₓO_{y} (wherein 0<x≤1 and 0<y≤1), a composite of Si and SiₓO_{y} (wherein 0<x≤1 and 0<y≤2), a composite of Ag and AgₓO_{y} (wherein 0<x≤2 and 0<y≤1), a composite of Al and AlₓO_{y} (wherein 0<x≤2 and 0<y≤3), a composite of Bi and BiₓO_{y} (wherein 0<x≤2 and 0<y≤3), a composite of Sn and SnₓO_{y} (wherein 0<x≤1 and 0<y≤2), a composite of Te and TeₓO_{y} (wherein 0<x≤1 and 0<y≤3), a composite of Zn and ZnₓO_{y} (wherein 0<x$1 and 0<y≤1), or a combination thereof.

The carbonaceous support may be, for example, amorphous carbon. The amorphous carbon may be, for example, carbon black (CB), acetylene black (AB), furnace black (FB), Ketjen black (KB), graphene, activated carbon, carbon nanofiber (CNF), or carbon nanotubes (CNT), but is not limited thereto, and a carbon classified as amorphous carbon in the art may also be used. Amorphous carbon may be carbon that does not have crystallinity, or has very low crystallinity, and may be distinguished from crystalline carbon or graphite-based carbon. The carbonaceous material may be, for example, a carbonaceous anode active material.

The composite anode active material may be, for example, in the form of particles. The composite anode active material in the form of particles may have a particle diameter of, for example, about 10 nm to about 4 μm, about 10 nm to about 1 μm, about 10 nm to about 500 nm, about 10 nm to about 200 nm, or about 10 nm to about 100 nm. With the average particle diameter of the composite anode active material satisfying the ranges described above, reversible absorbing and/or desorbing of lithium may occur more easily during charging and discharging. The metallic anode active material supported on the support may be, for example, in the form of particles. The metallic anode active material may have a particle diameter of, for example, about 1 nm to about 200 nm, about 1 nm to about 150 nm, about 5 nm to about 100 nm, or about 10 nm to about 50 nm. The carbonaceous support may be, for example, in the form of particles. The carbonaceous support may have a particle diameter of, for example, about 10 nm to about 2 μm, about 10 nm to about 1 μm, about 10 nm to about 500 nm, about 10 nm to about 200 nm, or about 10 nm to about 100 nm. With the particle diameter of the carbonaceous support satisfying the ranges described above, the carbonaceous support may be more uniformly arranged in the first anode active material layer. The carbonaceous support may be, for example, nanoparticles having a particle diameter of 500 nm or less. The particle diameter of the composite anode active material, the particle diameter of the metallic anode active material, and the particle diameter of the carbonaceous support may be, for example, average particle diameters. The average particle diameter may be, for example, an average diameter D50 measured using a laser particle size analyzer. Alternatively, the average particle diameter may be determined, for example, automatically using software or manually based on manuals from an electron microscope image.

The binder included in the first anode active material layer 22 may be, for example, styrene butadiene rubber (SBR), polytetrafluoroethylene, polyvinylidene fluoride, polyethylene, vinylidene fluoride/hexafluoropropylene copolymer, polyacrylonitrile, or polymethylmethacrylate, but is not limited thereto, and any binders commonly available in the art may also be used. The binder may be used alone or as a combination of a plurality of different binders.

Because the first anode active material layer 22 includes the binder, the first anode active material layer 22 is stabilized on the anode current collector 21. In addition, cracks may be inhibited in the first anode active material layer 22 during a charging and discharging process, although a volume and/or a relative position of the first anode active material layer 22 changes. For example, in the absence of the binder in the first anode active material layer 22, the first anode active material layer 22 may be easily separated from the anode current collector 21. Because the first anode active material layer 22 is separated from the anode current collector 21, an exposed region of the anode current collector 21 may be brought into contact with the electrolyte layer 30, thereby increasing the possibility of occurrence of a short circuit. The first anode active material layer 22 is prepared, for example, by applying a slurry in which a material constituting the first anode active material layer 22 is dispersed to the anode current collector 21, and drying the slurry. By adding the binder to the first anode active material layer 22, the anode active material may be stably dispersed in the slurry. For example, in the case of applying the slurry to the anode current collector 21 by screen printing, it may be possible to inhibit clogging of a screen (e.g., clogging by agglomerates of the anode active material).

The first anode active material layer 22 may further include an additive such as a filler, a coating agent, a dispersant, and an ion-conductive adjuvant, used in conventional lithium secondary batteries.

A ratio B/A of an initial charging capacity B of the first anode active material layer 22 to an initial charging capacity A of the cathode active material layer 12 may be about 0.005 to about 0.45. The initial charging capacity of the cathode active material layer 12 may be determined at a maximum charging voltage relative Li/Li⁺ from a 1^{st} open circuit voltage. The initial charging capacity of the first anode active material layer 22 is determined at 0.01 V relative to Li/Li⁺ from a 2^{nd} open circuit voltage.

The maximum charging voltage may be determined according to the types of the composite cathode active material. The maximum charging voltage may be, for example, 1.5 V, 2.0 V, 2.5 V, 3.0 V, 3.5 V, 4.0 V, 4.2 V, or 4.3 V. For example, a maximum charging voltage of the Li₂S or Li₂S composite may be 2.5 V relative to Li/Lit. For example, the maximum charging voltage of the Li₂S or Li₂S composite may be 3.0 V relative to Li/Lit. The ratio B/A of the initial charging capacity B of the first anode active material layer 22 to the initial charging capacity A of the cathode active material layer 12 may be, for example, about 0.01 to about 0.3, about 0.01 to about 0.2, or about 0.05 to about 0.1. The initial charging capacity (mAh) of the cathode active material layer 12 may be calculated by multiplying a charge specific capacity (mAh/g) of the composite cathode active material by a mass (g) of the composite cathode active material of the cathode active material layer 12. In the case of using various types of composite cathode active materials, charge specific capacity×mass values of all of the composite cathode active materials are calculated, respectively, and a sum of the values is regarded as the initial charging capacity of the cathode active material layer 12. The initial charging capacity of the first anode active material layer 22 may be calculated in the same manner. The initial charging capacity of the first anode active material layer 22 may be obtained by multiplying a charge specific capacity (mAh/g) of the anode active material by a mass of the anode active material of the first anode active material layer 22. In the case of using various types of anode active materials are used, charge specific capacity×mass values for all of the anode active materials are calculated respectively, and a sum of the values may be regarded as the initial charging capacity of the first anode active material layer 22. The charge specific capacity of each of the composite cathode active material and the anode active material may be measured by using an all-solid half-cell using lithium metal as a counter electrode. The initial charging capacities of the cathode active material layer 12 and the first anode active material layer 22 may be directly measured respectively at a constant current density, e.g., 0.1 mA/cm², by using an all-solid half-cell. The measurement may be performed on the cathode with an operating voltage from the 1^{st} open circuit voltage (OCV) to the maximum charging voltage, e.g., 3.0 V (vs. Li/Li⁺). The measurement may be performed on the anode, e.g., lithium metal, with an operating voltage from the 2^{nd} open circuit voltage (OCV) to 0.01 V. For example, an all-solid half-cell including the cathode active material layer may be charged at a constant current of 0.1 mA/cm² from the 1^{st} open circuit voltage to 3.0 V, and the all-solid half-cell including the first anode active material layer may be charged at a constant current of 0.1 mA/cm² from the 2^{nd} open circuit voltage to 0.01 V. A current density during the charging at the constant current may be, for example, 0.2 mA/cm² or 0.5 mA/cm². An all-solid half-cell including the cathode active material layer may be charged, for example, from the 1^{st} open circuit voltage to 2.5 V, 2.0 V, 3.5 V, or 4.0 V. The maximum charging voltage of the cathode active material may be determined by a maximum voltage of a battery satisfying safety conditions according to JISC8712:2015 of the Japanese Standards Association.

If the initial charging capacity of the first anode active material layer 22 is too low, the anode active material layer 22 becomes too thin, so that lithium dendrite formed between the first anode active material layer 22 and the anode current collector 21 during repeated charging and discharging processes breaks the first anode active material layer 22, making it difficult to improve cycle characteristics of the lithium secondary battery 1. If the charging capacity of the first anode active material layer 22 is too high, energy density of the lithium secondary battery 1 decreases and internal resistance of the lithium secondary battery 1 is increased by the first anode active material layer 22, making it difficult to improve cycle characteristics of the lithium secondary battery 1.

A thickness of the first anode active material layer 22 is, for example, 50% or less, 40% or less, 30% or less, 20% or less, 10% or less, or 5% or less of a thickness of the cathode active material layer 12. The thickness of the first anode active material layer 22 may be, for example, about 1% to about 50%, about 1% to about 40%, about 1% to about 30%, about 1% to about 20%, about 1% to about 10%, or about 1% to about 5% of the thickness of the cathode active material layer 12. The thickness of the first anode active material layer 22 may be, for example, about 1 μm to about 20 μm, about 2 μm to about 15 μm, or about 3 μm to about 10 μm. If the first anode active material layer 22 is too thin, lithium dendrite formed between the first anode active material layer 22 and the anode current collector 21 breaks the first anode active material layer 22, making it difficult to improve cycle characteristics of the lithium secondary battery 1. If the first anode active material layer 22 is too thick, energy density of the lithium secondary battery 1 decreases and internal resistance of the lithium secondary battery 1 is increased by the first anode active material layer 22, making it difficult to improve cycle characteristics of the lithium secondary battery 1. If the thickness of the first anode active material layer 22 decreases, for example, an initial charging capacity of the first anode active material layer 22 may also decrease.

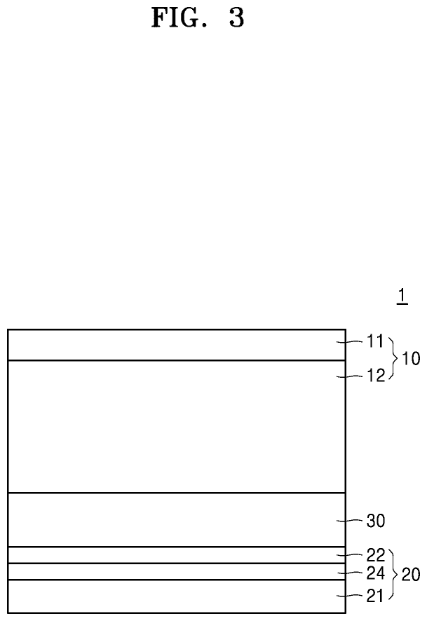

Referring to FIG. 3, the lithium secondary battery 1 may further include, for example, a second anode active material layer 24 disposed between the anode current collector 21 and the first anode active material layer 22 after charging. The second anode active material layer 24 may be a metal layer including lithium or a lithium alloy. The metal layer includes lithium or a lithium alloy. Therefore, the second anode active material layer 24, as a metal layer including lithium, may serve as a reservoir of lithium. The lithium alloy is, for example, an Li—Al alloy, an Li—Sn alloy, an Li—In alloy, an Li—Ag alloy, an Li—Au alloy, an Li—Zn alloy, an Li—Ge alloy, or an Li—Si alloy, but is not limited thereto, and any lithium alloy commonly available in the art may also be used. The second anode active material layer 24 may be formed of one of the alloys alone, lithium, or a combination of various types of alloys. The second anode active material layer 24 may be, for example, a plated layer. For example, the second anode active material layer 24 may be plated between the first anode active material layer 22 and the anode current collector 21 during a charging process of the lithium secondary battery 1.

A thickness of the second anode active material layer 24 is not particularly limited, but may be, for example, about 1 μm to about 500 μm, about 1 μm to about 200 μm, about 1 μm to about 150 μm, about 1 μm to about 100 μm, or about 1 μm to about 50 μm. With a too small thickness of the second anode active material layer 24, the function of the second anode active material layer 24 as a reservoir of lithium may be difficult to obtain. With a too large thickness of the second anode active material layer 24, the mass and volume of the lithium secondary battery 1 increase, and thus cycle characteristics of the lithium secondary battery 1 may deteriorate.

Alternatively, in the lithium secondary battery 1, the second anode active material layer 24 may be disposed between the anode current collector 21 and the first anode active material layer 22 before assembling the lithium secondary battery 1. If the second anode active material layer 24 is disposed between the anode current collector 21 and the first anode active material layer 22 before assembling the lithium secondary battery 1, the second anode active material layer 24, as a metal layer including lithium, serves as a reservoir of lithium. For example, before assembling the lithium secondary battery 1, a lithium foil may be disposed between the anode current collector 21 and the first anode active material layer 22.

If the second anode active material layer 24 is plated during charging after assembling the lithium secondary battery 1, energy density of the lithium secondary battery 1 increases because the second anode active material layer 24 is not included while the lithium secondary battery 1 is assembled. While the lithium secondary battery 1 is charged, charging is performed to exceed the charging capacity of the first anode active material layer 22. That is, the first anode active material layer 22 is overcharged. During initial charging, lithium is absorbed to the first anode active material layer 22. The anode active material included in the first anode active material layer 22 may form an alloy or compound with lithium ions that have migrated from the cathode 10. If the first anode active material layer 22 is overcharged to exceed the capacity thereof, lithium may be plated on the rear surface of the first anode active material layer 22, i.e., between the anode current collector 21 and the first anode active material layer 22, and a metal layer corresponding to the second anode active material layer 24 may be formed by the plated lithium. The second anode active material layer 24 may be a metal layer mainly composed of lithium (i.e., lithium metal). These results are obtained because the anode active material included in the first anode active material layer 22 includes a material forming an alloy or compound with lithium. During discharging, lithium of the first anode active material layer 22 and the second anode active material layer 24, i.e., the metal layer, may be ionized to migrate in a direction toward the cathode 10. Therefore, it is possible to use lithium as an anode active material in the lithium secondary battery 1. Also, the first anode active material layer 22 may serve as a protective layer for the second anode active material layer 24, i.e., the metal layer, to prevent formation and growth of lithium dendrite, because the first anode active material layer 22 covers the second anode active material layer 24. Therefore, a short circuit and capacity reduction are inhibited in the lithium secondary battery 1, so that cycle characteristics of the lithium secondary battery 1 are improved. In addition, if the second anode active material layer 24 is disposed by charging after assembling the lithium secondary battery 1, the anode 20, i.e., the anode current collector 21, the first anode active material layer 22, and a region therebetween, is a Li-free region not including lithium (Li) in the early stage of charging or after completely discharging the lithium secondary battery 1.

The anode current collector 21 may be formed of, for example, a material that does not react with lithium, i.e., a material that does not form an alloy and compound with lithium. The material constituting the anode current collector 21 may be, for example, copper (Cu), stainless steel, titanium (Ti), iron (Fe), cobalt (Co), and nickel (Ni), but is not limited thereto, and may be any materials commonly available in the art as electrode current collectors. The anode current collector 21 may be formed of one metal selected from those described above or an alloy or coating material of two or more metals selected therefrom. The anode current collector 21 may be, for example, in the form of a plate or foil.

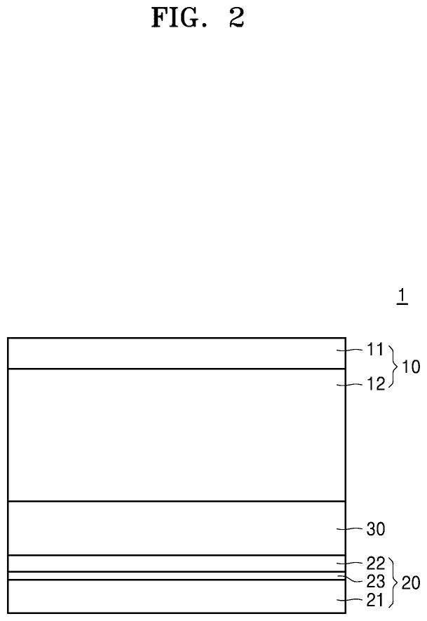

Referring to FIG. 2, the lithium secondary battery 1 may further include a thin film 23 containing an element capable of forming an alloy with lithium on one side of the anode current collector 21. The thin film 23 may be disposed between the anode current collector 21 and the first anode active material layer 22. The thin film 23 may include, for example, an element capable of forming an alloy with lithium. Examples of the element capable of forming an alloy with lithium include gold, silver, zinc, tin, indium, silicon, aluminum, and bismuth, but are not limited thereto, and any elements capable of forming an alloy with lithium well known in the art may also be used. The thin film 23 may be formed of any one of the metals or an alloy of various types of metals. By disposing the thin film 23 on one surface of the anode current collector 21, the second anode active material layer 24 plated between the thin film 23 and the first anode active material layer 22 becomes flatter, thereby further improving cycle characteristics of the lithium secondary battery 1.

For example, the thin film 23 may have a thickness of about 1 nm to about 800 nm, about 10 nm to about 700 nm, about 50 nm to about 600 nm, or about 100 nm to about 500 nm. If the thickness of the thin film 23 is less than 1 nm, the function of the thin film 23 may be difficult to obtain. If the thickness of the thin film 23 is too large, the thin film 23 absorbs lithium and an amount of plated lithium decreases in the anode, and thus energy density of the lithium secondary battery 1 may decrease and cycle characteristics of the lithium secondary battery 1 may deteriorate. The thin film 23 may be formed on the anode current collector 21 by, for example, vacuum deposition, sputtering, or plating. However, the method is not limited thereto and any method commonly used in the art to form a thin film 23 may also be used.

Although not shown in the drawings, the anode current collector 21 may include, for example, a base film and a metal layer disposed on one side or both sides of the base film. The base film may include, for example, a polymer. The polymer may be, for example, a thermoplastic polymer. The polymer may include, for example, polyethylene terephthalate (PET), polyethylene (PE), polypropylene (PP), polybutylene terephthalate (PBT), polyimide (PI), or a combination thereof. The polymer may be an insulating polymer. If the base film includes an insulating thermoplastic polymer, the base film may soften or liquefy in the event of a short circuit to stop the operation of a battery, thereby inhibiting a rapid increase in currents. The metal layer may include, for example, copper (Cu), stainless steel, titanium (Ti), iron (Fe), cobalt (Co), nickel (Ni), or an alloy thereof. The anode current collector 21 may further include a metal chip and/or a lead tab. For detailed descriptions of the base film, the metal layer, the metal chip, and the lead tab of the anode current collector 21, refer to the above-described cathode current collector 11. If the anode current collector 21 has the above-described structure, the weight of the anode may be reduced, so that energy density of the anode and the lithium battery may be increased.

Subsequently, a separator to be inserted between the cathode and the anode is prepared.

Any separator commonly used in the art for lithium batteries may be used. For example, any separator having low resistance to ion migration of the electrolyte and excellent electrolyte-retaining ability may be used. For example, the separator may be glass fiber, polyester, polyethylene, polypropylene, polytetrafluoroethylene (PTFE, also known as TEFLON), or a combination thereof, each of which is a non-woven or woven fabric. For example, a windable separator such as polyethylene or polypropylene may be used in lithium-ion batteries and a separator having excellent organic electrolyte-retaining ability may be used in lithium-ion polymer batteries.

The separator may be prepared according to the following exemplary method. However, the method is not limited thereto and adjusted according to required conditions.

First, a polymer, a filler, and a solvent may be mixed to prepare a separator composition. The separator composition may directly be applied onto an electrode and dried to prepare a separator. Alternatively, the separator composition is cast on a support and dried and then a separator film separated from the support is laminated on an electrode to form a separator.

The polymer used to prepare the separator is not particularly limited and any polymer commonly used as a binder for electrode plates may also be used. For example, a vinylidene fluoride/hexafluoropropylene copolymer, polyvinylidene fluoride (PVDF), polyacrylonitrile, polymethyl methacrylate, or any mixture thereof may be used.

Subsequently, an electrolyte may be prepared.

Referring to FIGS. 1 to 5, the electrolyte layer 30 is disposed between the cathode 10 and the anode 20 and includes a sulfide-based solid electrolyte.

The sulfide-based solid electrolyte may include, for example, at least one of Li₂S—P₂S₅, Li₂S—P₂S₅—LiX where X is a halogen atom, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ where m and n are positive numbers, and Z is Ge, Zn, or Ga, Li₂S—GeS₂, Li₂S—SiS₂—Li₃PO₄, Li₂S—SiS₂—LiₚMO_{q} where p and q are positive numbers and M is P, Si, Ge, B, Al, Ga, or In, Li₇₋ₓPS₆₋ₓClₓ where 0≤x≤2, Li₇₋ₓPS₆₋ₓBrₓ where 0≤x≤2, Li₇₋ₓPS₆₋ₓIₓ where 0≤x≤2, or a combination thereof. The sulfide-based solid electrolyte may be prepared by treating a starting material such as Li₂S and P₂S₅ by melt quenching or mechanical milling. Heat treatment may be performed after such treatment. The solid electrolyte may be in an amorphous state, a crystalline state, or a mixed state thereof. In addition, the solid electrolyte may include, for example, sulfur(S), phosphorus (P), and lithium (Li) as components among materials of the above-described sulfide-based solid electrolytes. For example, the solid electrolyte may be a material including Li₂S—P₂S₅. In the case of using the material including Li₂S—P₂S₅ as the sulfide-based solid electrolyte material constituting the solid electrolyte, a mixing molar ratio of Li₂S to P₂S₅ may be, for example, about 20:80 to about 90:10, about 25:75 to about 90:10, about 30:70 to about 70:30, or about 40:60 to about 60:40.

The sulfide-based solid electrolyte may include, for example, an argyrodite type solid electrolyte represented by Formula 1 below.

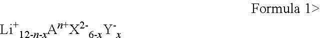

In Formula 1, A is P, As, Ge, Ga, Sb, Si, Sn, Al, In, Ti, V, Nb, or Ta, X is S, Se, or Te, and Y is Cl, Br, I, F, CN, OCN, SCN, or N₃, wherein 1≤n≤5 and 0≤x≤2. The sulfide-based solid electrolyte may be an argyrodite-type compound including, for example, at least one of Li₇₋ₓPS₆₋ₓClₓ where 0≤x≤2, Li₇₋ₓPS₆₋ₓBrₓ, where 0≤x≤2, or Li₇₋ₓPS₆₋ₓIₓ where 0≤x≤2. The sulfide-based solid electrolyte may be an argyrodite-type compound including, for example, at least one of Li₃PS₅Cl, Li₃PS₅Br, or Li₆PS₅I.

The argyrodite-type solid electrolyte may have a density of about 1.5 g/cc to about 2.0 g/cc. Because the argyrodite-type solid electrolyte has a density of 1.5 g/cc or more, internal resistance of the lithium secondary battery may be reduced and penetration of the electrolyte layer may be effectively inhibited.

Due to excellent lifespan characteristics and high rate properties, the lithium secondary batteries may be used in, for example, electric vehicles (EVs). For example, lithium secondary batteries may be used in hybrid vehicles such as plug-in hybrid electric vehicles (PHEVs). Also, lithium batteries may be used in the fields requiring a large amount of power storage. For example, lithium batteries may be used in E-bikes and electric tools.

A plurality of lithium batteries may be stacked to form a battery module, and a plurality of battery modules constitute a battery pack. Such battery packs may be used in any device that requires high capacity and high output. For example, battery packs may be used in laptop computers, smart phones, and electric vehicles. For example, a battery module includes a plurality of batteries and a frame holding the batteries. The battery pack may include, for example, a plurality of battery modules and a bus bar connecting the battery modules. The battery module and/or the battery pack may further include a cooling device. The plurality of battery packs are controlled by a battery management system. The battery management system includes a battery pack, and a battery control device connected to the battery pack.

Hereinafter, the disclosure will be described in detail with reference to the following examples and comparative examples. However, these examples are not intended to limit the purpose and scope of the one or more embodiments.

### EXAMPLES

### Evaluation Example 1: Evaluation of Binder Solubility

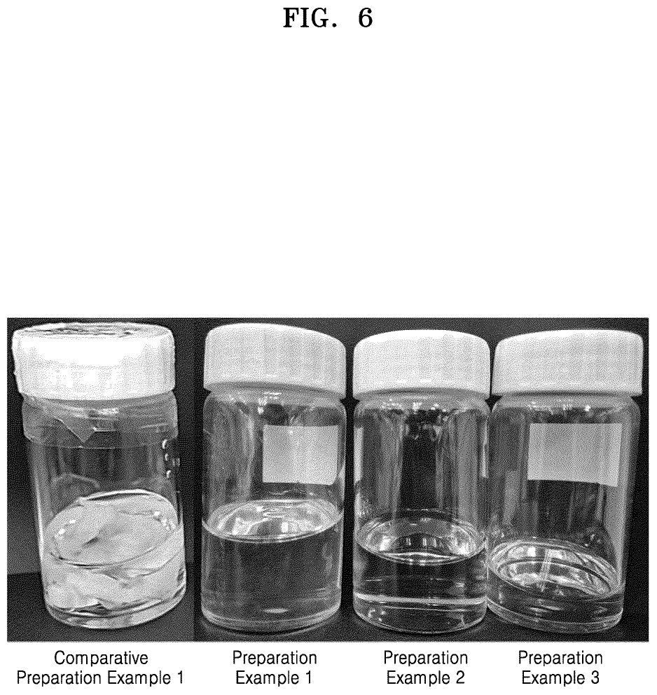

Binders and solvents were prepared according to Preparation Examples 1 to 4 and Comparative Preparation Example 1 as shown in Table 1 below, where “EPM” is a binder derived from ethylene and propylene, “EPDM” is a binder derived from ethylene, propylene, and ethylidene norbornene (ENB) monomers, and “PVDF” is a polyvinylidene fluoride binder. 2 g of each of the binders was added to 100 mL of tetralin, as a non-polar solvent, and stirred in a stirrer for 10 minutes to prepare samples, respectively. While visually observing each sample, solubility was evaluated. A case where the binder was completely dissolved in the solvent was evaluated as O, a case where fine particles remained was evaluated as Δ, and a case where the binder was not dissolved was evaluated as X. The evaluation results are shown in Table 1 and FIG. 6.

TABLE 1

| | | Amount of | | | |
|---|---|---|---|---|---|
| | | ethylene- | Amount of | | |
| | | derived | ENB-derived | | Evaluation |
| | Binder | repeating | repeating | | of |
| Category | Type | unit | unit | Solvent | solubility |
| Preparation | EPM | 53.5 wt % | 0 | tetralin | ◯ |
| Example 1 | | | | | |
| Preparation | EPDM | 50 wt % | 7.5 | tetralin | ◯ |
| Example 2 | | | | | |
| Preparation | EPDM | 52 wt % | 10 | tetralin | ◯ |
| Example 3 | | | | | |
| Preparation | EPM | 58 wt % | 0 | tetralin | Δ |
| Example 4 | | | | | |
| Comparative | PVDF | — | — | tetralin | X |
| Preparation | | | | | |
| Example 1 | | | | | |

Referring to Table 1, it was confirmed that PVDF was not dissolved in tetralin. In addition, with an amount of the ethylene-derived repeating unit exceeding 55 wt %, solubility in tetralin decreased.

### Preparation of Cathode Slurry Composition

### Preparation Example 1: Tetralin+EPM

85 parts by weight of NCA (lithium nickel-cobalt-aluminum oxide, Ni 94%) coated with Li₂O—ZrO₂ (LZO) as a cathode active material, 1 part by weight of EPM as a binder, 13 parts by weight of Li₃PS₅Cl as a sulfide-based solid electrolyte (argyrodite), and 1 part by weight of carbon nanotube (CNT) were dissolved in tetralin (TL) as a non-polar solvent to prepare a cathode slurry composition. In the EPM, a content of a repeating unit derived from ethylene was 53.5 wt % and a content of a repeating unit derived from ethylidene norbornene was 0 wt %.

### Preparation Examples 2 to 6 and Comparative Examples 1 and 2

Cathode slurry compositions were prepared in the same manner in Example 1, except that types of the solvent and the binder were modified as shown in Table 2 below.

TABLE 2

| | Solvent | | | Binder | | | |
|---|---|---|---|---|---|---|---|
| | | Molecular | Boiling | | Content of | | Content of |
| | | weight | point | | ethylene-derived | | ENB-derived |
| Category | Type | (g/mol) | (° C.) | Type | repeating unit | | repeating unit |
| Example 1 | tetralin (TL) | 132.2 | 207 | EPM | 53.5 | wt % | 0 |
| Example 2 | tetralin (TL) | 132.2 | 207 | EPDM | 50 | wt % | 7.5 wt % |
| Example 3 | tetralin (TL) | 132.2 | 207 | EPDM | 52 | wt % | 10 wt % |
| Example 4 | diisopropyl | 162.28 | 203 | EPM | 53.5 | wt % | 0 |
| | benzene | | | | | | |
| Example 5 | 1,3,5- | 120.19 | 164 | EPM | 53.5 | wt % | 0 |
| | trimethyl | | | | | | |
| | benzene | | | | | | |
| Example 6 | tetralin(TL) | 132.2 | 207 | EPM | 58 | wt % | 0 |
| Comparative | octyl acetate | 172.26 | 211.5 | PVDF | — | | — |
| Example 1 | (OA) | | | | | | |
| Comparative | octyl acetate | 172.26 | 211.5 | EPM | 53.5 | wt % | 0 |
| Example 2 | (OA) | | | | | | |

### Evaluation Example 2: Evaluation of Stability

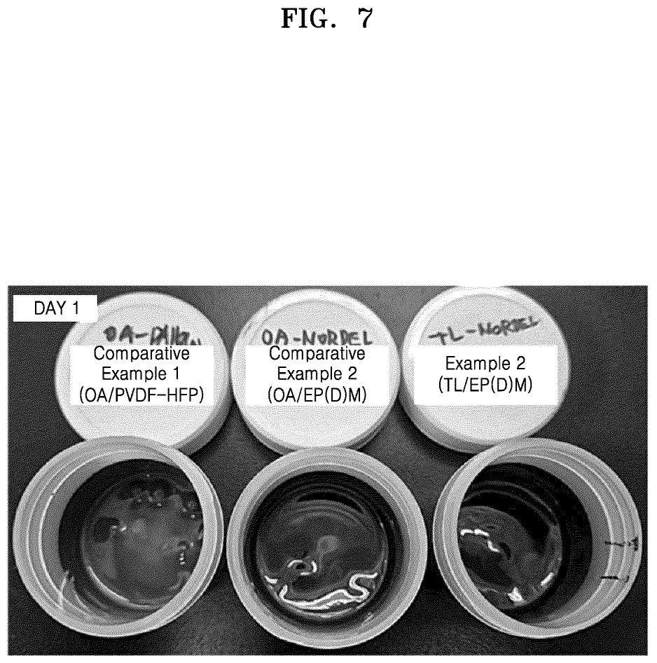

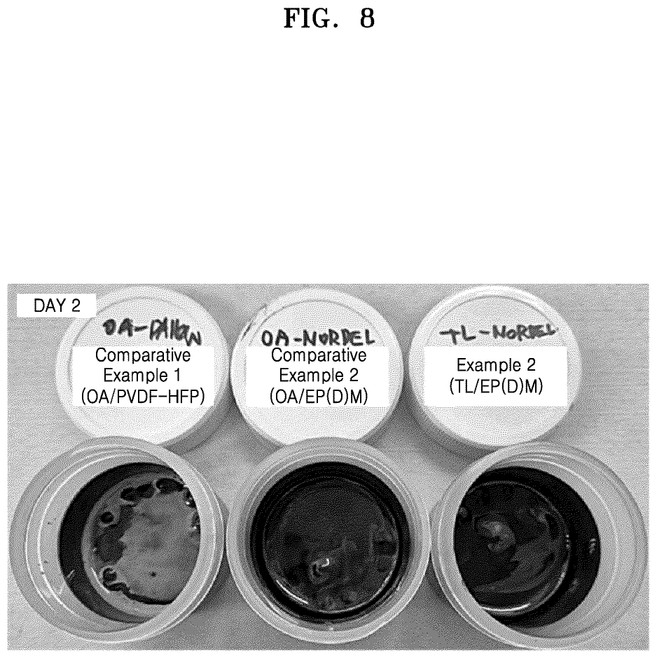

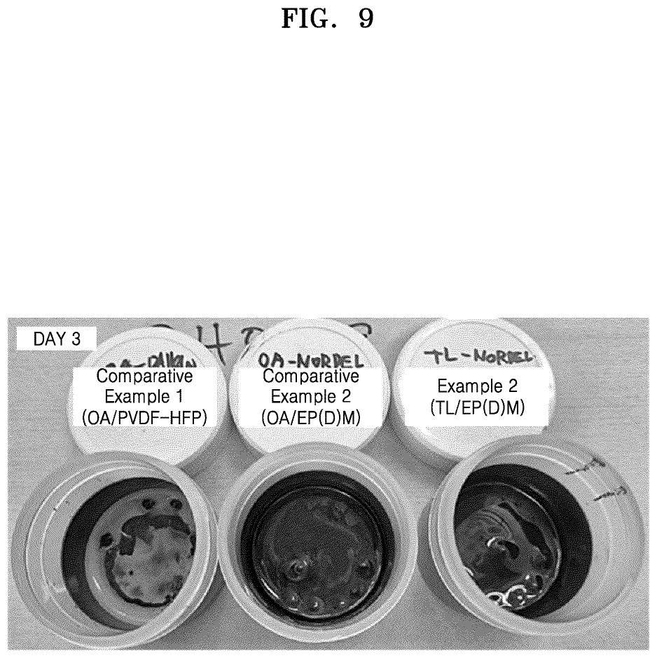

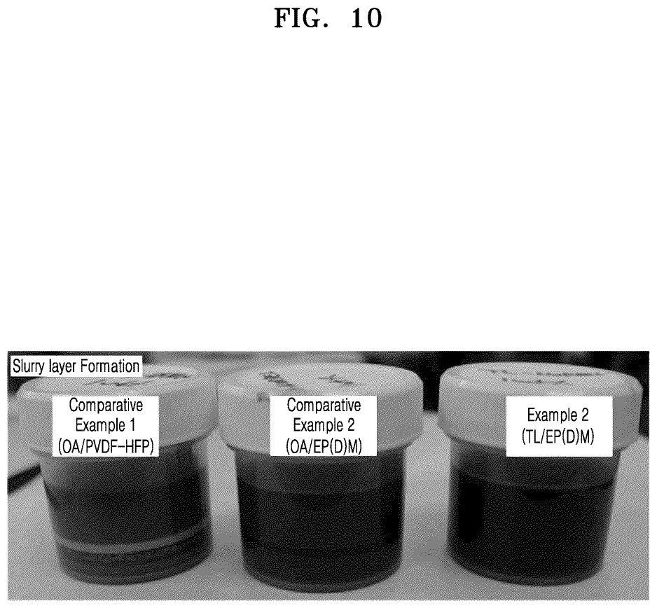

The cathode slurry compositions according to Examples 1 to 6 and Comparative Examples 1 and 2 were left standing at room temperature. Formation of by-products on the surface of the cathode slurry compositions was evaluated on Day 1, Day 2, and Day 3. A case where by-products and layer separation were observed was marked with X, a case where a small amount of by-products was observed was marked with Δ, and a case where no by-products were observed was marked with O. The evaluation results are shown in Table 3 below and FIGS. 7 to 10.

TABLE 3

| | Day 1 | Day 2 | Day 3 |
|---|---|---|---|
| Example 1 | ◯ | ◯ | ◯ |
| Example 2 | ◯ | ◯ | ◯ |
| Example 3 | ◯ | ◯ | ◯ |
| Example 4 | ◯ | ◯ | ◯ |
| Example 5 | ◯ | ◯ | ◯ |
| Example 6 | ◯ | ◯ | ◯ |
| Comparative Example 1 | Δ | X | X |
| Comparative Example 2 | ◯ | Δ | Δ |

Referring to Table 3 and FIGS. 7 to 10, no by-products were observed in the cathode slurry compositions according to Examples 1 to 6 indicating excellent stability. On the contrary, by-products were observed in the cathode slurry compositions according to Comparative Examples 1 and 2, and layer separation was observed in the slurry in Comparative Example 1.

In addition, the cathode slurry composition according to an embodiment Example 2 (TL+EPDM) exhibited adhesion strength to the substrate similar to that of Comparative Example 1 (OA+PVDF-HFP).

### Example 1-1: Preparation of Lithium Secondary Battery (Full Cell)

### Preparation of Cathode

The cathode slurry composition according to Example 1 was applied to an aluminum current collector having a thickness of 10 μm by bar coating and dried at 80° C., and then dried again in a vacuum at 70° C. and rolled and calendered to prepare a cathode having a thickness of 70 μm.

### Preparation of Pouch Cell

Lithium secondary batteries were prepared by using the cathode manufactured as described above, an Ag—C composite anode as a counter electrode, and a sulfide solid electrolyte as a separator and electrolyte.

### Examples 2-1 to 5-1 and Comparative Example 1-1

Lithium secondary batteries were prepared in the same manner as in Example 1, except that the cathode slurry compositions prepared in Examples 2 to 5 and Comparative Example 1 were used instead of the cathode slurry composition prepared in Example 1.

### Evaluation Example 4: Evaluation of High-Temperature DC-IR and High-Rate Characteristics

Each of the lithium secondary batteries prepared in Examples 1-1 to 5-1 and Comparative Example 1-1 was charged at a constant current of 0.1 C rate at 45° C. until a voltage reached 4.3 V (vs. Li), and the charging process was cut-off at a rate of 0.05 C rate in a constant voltage mode while the voltage of 4.3 V was maintained. Subsequently, the lithium battery was discharged with a constant current of 0.1 C rate until the voltage reached 2.5 V (vs. Li) during discharging (formation cycle).

The lithium battery that had undergone the formation cycle was charged at a constant current of 0.1 C rate at 45° C. until the voltage reached 4.3 V (vs. Li), and then the charging process was cut-off at a current of 0.05 C rate in a constant voltage mode while maintaining the voltage of 4.3 V. Subsequently, the lithium battery was discharged with a constant current of 0.1 C rate until the voltage reached 2.5 V (vs. Li) during discharging (1^{st} cycle).

The lithium battery that had undergone the 1^{st} cycle was charged at a constant current of 0.33 C rate at 45° C. until the voltage reached 4.3 V (vs. Li), and then the charging process was cut-off at a current of 0.05 C rate in a constant voltage mode while maintaining the voltage of 4.3 V. Subsequently, the lithium battery was discharged with a constant current of 0.33 C rate until the voltage reached 2.5 V (vs. Li) during discharging (2^{nd} cycle).

In this regard, DC internal resistance (DC-IR) was calculated by measuring voltage drop (V) caused by applying a current of 0.33 C for 1 second at an SOC of 10 (where the battery is charged to have a charging capacity of 10% on the assumption that a full charging capacity of the battery is 100%, i.e., the battery is discharged by 90% when viewed in the discharge state).

The lithium battery that had undergone the 2^{nd} cycle was charged at a constant current of 0.1 C rate at 45° C. until the voltage reached 4.3 V (vs. Li), and then the charging process was cut-off at a current of 0.05 C rate in a constant voltage mode while maintaining the voltage of 4.3 V. Subsequently, the lithium battery was discharged with a constant current of 1 C rate until the voltage reached 2.5 V (vs. Li) during discharging (3^{rd} cycle).

The lithium batteries were rested for 10 minutes after every charging/discharging cycle. Discharging capacity and DC internal resistance (DC-IR) were measured at each cycle and the results are shown in Tale 4 below.

TABLE 4

| | | Discharging capacity | | |
|---|---|---|---|---|
| | DC-IR | 0.1 C | 0.33 C | 1 C |
| | (Ω · cm²) | (mAh/g) | (mAh/g) | (mAh/g) |
| Example 1-1 | 10.67 | 206.13 | 183.79 | 167.84 |
| Example 2-1 | 13.38 | 207.10 | 194.42 | 181.43 |
| Example 3-1 | 16.14 | 198.58 | 185.45 | 173.33 |
| Example 4-1 | 16.10 | 208.84 | 196.19 | 184.33 |
| Example 5-1 | 14.03 | 208.30 | 195.7 | 183.56 |
| Comparative | 19.05 | 197.49 | 183.79 | 167.84 |
| Example 1-1 | | | | |

As shown in Table 4, the lithium secondary batteries according to Examples 1-1 to 5-1 had improved high-temperature resistance characteristics and discharge characteristics, compared to the lithium secondary battery according to Comparative Example 1-1.

### Evaluation Example 5: Evaluation of Room Temperature DC-IR and High-Rate Characteristics

Each of the lithium secondary batteries prepared in Examples 1-1 to 5-1 and Comparative Example 1-1 was charged at a constant current of 0.1 C rate at 25° C. until a voltage reached 4.3 V (vs. Li), and the charging process was cut-off at a rate of 0.05 C rate in a constant voltage mode while the voltage of 4.3 V was maintained. Subsequently, the lithium battery was discharged at a constant current of 0.1 C rate until the voltage reached 2.5 V (vs. Li) during discharging (formation cycle).

The lithium battery that had undergone the formation cycle was charged at a constant current of 0.1 C rate at 25° C. until the voltage reached 4.3 V (vs. Li), and then the charging process was cut-off at a current of 0.05 C rate in a constant voltage mode while maintaining the voltage of 4.3 V. Subsequently, the lithium battery was discharged with a constant current of 0.1 C rate until the voltage reached 2.5 V (vs. Li) during discharging (1^{st} cycle).

The lithium battery that had undergone the 1^{st} cycle was charged at a constant current of 0.33 C rate at 25° C. until the voltage reached 4.3 V (vs. Li), and then the charging process was cut-off at a current of 0.05 C rate in a constant voltage mode while maintaining the voltage of 4.3 V. Subsequently, the lithium battery was discharged with a constant current of 0.33 C rate until the voltage reached 2.5 V (vs. Li) during discharging (2^{nd} cycle).

In this regard, DC internal resistance (DC-IR) was calculated by measuring voltage drop (V) caused by applying a current of 0.33 C for 1 second at an SOC of 10 (where the battery is charged to have a charging capacity of 10% on the assumption that a full charging capacity of the battery is 100%, i.e., the battery is discharged by 90% when viewed in the discharge state).

The lithium battery that had undergone the 2^{nd} cycle was charged at a constant current of 1 C rate at 25° C. until the voltage reached 4.3 V (vs. Li), and then the charging process was cut-off at a current of 0.05 C rate in a constant voltage mode while maintaining the voltage of 4.3 V. Subsequently, the lithium battery was discharged with a constant current of 1 C rate until the voltage reached 2.5 V (vs. Li) during discharging (3^{rd} cycle).

The lithium batteries were rested for 10 minutes after every charging/discharging cycle. Discharging capacity was measured at each cycle and the results are shown in Table 5 below.

TABLE 5

| | | Discharging capacity | | |
|---|---|---|---|---|
| | DC-IR | 0.1 C | 0.33 C | 1 C |
| | (Ω · cm²) | (mAh/g) | (mAh/g) | (mAh/g) |
| Example 1-1 | 28.27 | 186.79 | 135.44 | 39.26 |
| Example 2-1 | 30.36 | 185.24 | 171.83 | 81.90 |
| Example 3-1 | 34.11 | 180.84 | 166.81 | 145.25 |
| Example 4-1 | 31.59 | 190.06 | 177.26 | 155.98 |
| Example 5-1 | 33.61 | 186.70 | 172.73 | 110.69 |
| Comparative | 75.22 | 157.36 | 135.44 | 39.26 |
| Example 1-1 | | | | |

As shown in Table 5, the lithium secondary batteries according to Examples 1-1 to 5-1 had improved room temperature resistance characteristics and discharge characteristics, compared to the lithium secondary battery according to Comparative Example 1-1.

According to an embodiment, side reactions between the cathode slurry composition, which includes the non-polar solvent and the binder including at least two of the ethylene-based monomer-derived repeating unit a, the propylene-based monomer-derived repeating unit b, and the diene-based monomer-derived repeating unit c, and the sulfide-based solid electrolyte, may be inhibited so that storage characteristics may be improved.

The lithium secondary battery including the cathode active material layer derived from the cathode slurry composition may have improved resistance characteristics and discharge characteristics due to reduced side reactions with the sulfide-based solid electrolyte.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A cathode slurry composition comprising:
a non-polar solvent;
a sulfide-based solid electrolyte;
a cathode active material comprising a lithium transition metal oxide; and
a binder,
wherein the binder comprises at least two of an ethylene-based monomer-derived repeating unit a, a propylene-based monomer-derived repeating unit b, or a diene-based monomer-derived repeating unit c.

2. The cathode slurry composition of claim 1, wherein
the binder comprises the ethylene-based monomer-derived repeating unit a and the propylene-based monomer-derived repeating unit b.

3. The cathode slurry composition of claim 1, wherein
the ethylene-based monomer-derived repeating unit a is represented by Formula 1, and
the propylene-based monomer-derived repeating unit b is represented by Formula 2: 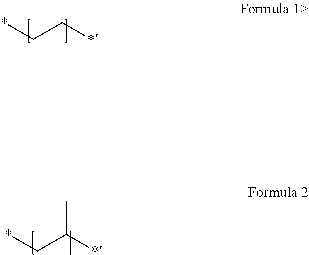
wherein in Formulae 1 and 2,
* and *′ are each independently a binding site with an adjacent repeating unit.

4. The cathode slurry composition of claim 1, wherein
the diene-based monomer comprises ethylidene norbornene.

5. The cathode slurry composition of claim 1, wherein
the diene-based monomer-derived repeating unit c is a represented by Formula 3: 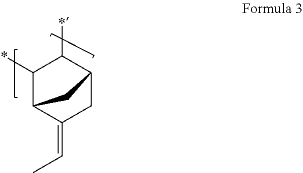
wherein in Formula 3,
* and *′ are each independently a binding site with an adjacent repeating unit.

6. The cathode slurry composition of claim 1, wherein
an amount of the ethylene-based monomer-derived repeating unit a included in the binder is 55 wt % or less based on a total weight of the binder.

7. The cathode slurry composition of claim 1, wherein
an amount of the diene-based monomer-derived repeating unit c included in the binder is 10 wt % or less based on a total weight of the binder.

8. The cathode slurry composition of claim 1, wherein
a Mooney viscosity of the binder is 60 or more, as measured using a Mooney viscometer for 4 minutes at 125° C. after 1 minute of preheating.

9. The cathode slurry composition of claim 1, wherein
a molecular weight of the non-polar solvent is about 90 grams per mole to about 180 grams per mole.

10. The cathode slurry composition of claim 1, wherein
a boiling point of the non-polar solvent is about 110° C. to about 250° C.

11. The cathode slurry composition of claim 1, wherein
the non-polar solvent comprises tetralin, cymene, diisopropyl benzene, trimethyl benzene, toluene, or a combination thereof.

12. The cathode slurry composition of claim 1, wherein
the lithium transition metal oxide is represented by one of Formulae 5 to 12: 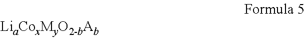
wherein in Formula 5,
1.0≤a≤1.2, 0≤b≤0.2, 0.9≤x≤1, 0≤y≤0.1, and x+y=1,
M is manganese, niobium, vanadium, magnesium, gallium, silicon, tungsten, molybdenum, iron, chromium, copper, zinc, titanium), aluminum, boron, or a combination thereof, and
A is F, S, Cl, Br, or a combination thereof, 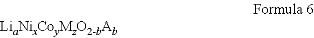
wherein in Formula 6,
1.0≤a≤1.2, 0≤b≤0.2, 0.8≤x<1, 0≤y≤0.3, 0<z≤0.3, and x+y+z=1,
M is manganese, niobium, vanadium, magnesium, gallium, silicon, tungsten, molybdenum, iron, chromium, copper, zinc, titanium, aluminum, boron, or a combination thereof, and
A is F, S, Cl, Br, or a combination thereof, 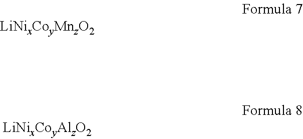
wherein in Formulae 7 and 8,
0.8≤x≤0.95, 0≤y≤0.2, 0<z≤0.2 and x+y+z=1, 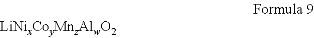
wherein in Formula 9,
0.8≤x≤0.95, 0≤y≤0.2, 0<z≤0.2, 0<w≤0.2, and x+y+z+w=1, 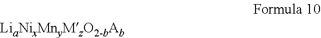
wherein in Formula 10,
1.0≤a≤1.2, 0≤b≤0.2, 0<x≤0.3, 0.5≤y<1, 0<z≤0.3, and x+y+z=1,
M′ is cobalt, niobium (Nb), vanadium (V), magnesium, gallium, silicon (Si), tungsten, molybdenum, iron, chromium, copper, zinc, titanium, aluminum, boron, or a combination thereof, and
A is F, S, Cl, Br, or a combination thereof, 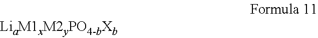
wherein in Formula 11,
0.90≤a≤1.1, 0≤x≤0.9, 0≤y≤0.5, 0.9<x+y<1.1, and 0≤b≤2,
M1 is chromium, manganese, iron, cobalt, nickel, copper, zirconium, or a combination thereof,
M2 is magnesium, calcium, strontium, barium, titanium, zinc, boron, niobium, gallium, indium, molybdenum, tungsten, aluminum, silicon, chromium, vanadium, scandium, yttrium, or a combination thereof, and
X is O, F, S, P or a combination thereof, 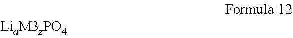
wherein in Formula 12,
0.90≤a≤1.1 and 0.9≤z≤1.1, and
M3 is chromium, manganese (Mn), iron (Fe), cobalt, nickel, copper, zirconium, or a combination thereof.

13. The cathode slurry composition of claim 1, wherein
the lithium transition metal oxide comprises a first particulate lithium transition metal oxide and a second particulate lithium transition metal oxide,
wherein the first lithium transition metal oxide is a large-diameter lithium transition metal oxide having a larger particle diameter than that of the second lithium transition metal oxide, and
the second lithium transition metal oxide is a small-diameter lithium transition metal oxide having a smaller particle diameter than that of the first lithium transition metal oxide.

14. The cathode slurry composition of claim 13, wherein
a particle diameter D50 of the first lithium transition metal oxide is about 10 micrometer to about 20 micrometer, and
a particle diameter D50 of the second lithium transition metal oxide is about 1 micrometer to about 10 micrometer.

15. The cathode slurry composition of claim 1, wherein
the sulfide-based solid electrolyte comprises Li₂S—P₂S₅, Li₂S—P₂S₅—LiX wherein X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ wherein m and n are positive numbers and Z is Ge, Zn, or Ga, Li₂S—GeS₂, Li₂S—SiS₂—Li₃PO₄, Li₂S—SiS₂—LiₚMO_{q} wherein p and q are positive numbers and M is P, Si, Ge, B, Al, Ga, or In, Li₇₋ₓPS₆₋ₓClₓ wherein 0≤x≤2, Li₇₋ₓPS₆₋ₓBrₓ wherein 0≤x≤2, Li₇₋ₓPS₆₋ₓIₓ wherein 0≤x≤2, or a combination thereof.

16. The cathode slurry composition of claim 1, wherein
the sulfide-containing solid electrolyte comprises an argyrodite-type solid electrolyte,
wherein the argyrodite-type solid electrolyte comprises Li₆PS₅Cl, Li₃PS₅Br, Li₆PS₅I, or a combination thereof.

17. The cathode slurry composition of claim 1, wherein
a particle diameter D50 of the sulfide-based solid electrolyte is 1 micrometer or less.

18. The cathode slurry composition of claim 1,
further comprising a conductive material, wherein
the conductive material comprises a linear carbonaceous material, and
the linear carbonaceous material is a single-walled carbon nanotube, a double-walled carbon nanotube, a multi-walled carbon nanotube, or a combination thereof.

19. A lithium secondary battery comprising:
a cathode;
an anode; and
an electrolyte layer disposed between the cathode and the anode,
wherein the electrolyte layer comprises a sulfide-containing solid electrolyte, and
the cathode comprises: a cathode current collector; and
a cathode active material layer disposed on the cathode current collector and derived from the cathode slurry composition of claim 1.

20. A method of manufacturing a cathode slurry composition, the method comprising
mixing a non-polar solvent, a sulfide-based solid electrolyte, a cathode active material including a lithium transition metal oxide, and a binder,
wherein the binder comprises at least two of an ethylene-based monomer-derived repeating unit a, a propylene-based monomer-derived repeating unit b, or a diene-based monomer-derived repeating unit c.
